(19) United States
(12) Patent Application Publication
(10) Pub. No.: US 2026/0230890 A1
(43) Pub. Date: Aug. 6, 2026

(54) TRUNCATED EVENT-TRIGGERED MEASUREMENT REPORT DESIGNS AND PROCEDURES IN LOWER-LAYER TRIGGERED MOBILITY

(71) Applicant: QUALCOMM Incorporated, San Diego, CA (US)

(72) Inventors: Doohyun SUNG, Basking Ridge, NJ (US); Jelena DAMNJANOVIC, Del Mar, CA (US); Sitaramanjaneyulu KANAMARLAPUDI, San Diego, CA (US); Junyi LI, Greentown, PA (US); Wooseok NAM, San Diego, CA (US)

(21) Appl. No.: 19/455,660

(22) Filed: Jan. 21, 2026

Related U.S. Application Data
(60) Provisional application No. 63/754,363, filed on Feb. 5, 2025.

(51) Int. Cl. H04W 24/10; H04W 28/06

(52) U.S. Cl. CPC H04W 24/10; H04W 28/06

(57) ABSTRACT

Methods, systems, and devices for wireless communications associated with lower-layer triggered mobility (LTM) are described. Various aspects relate generally to truncated event-triggered measurement report designs and procedures in LTM. Some aspects more specifically relate to mechanisms according to which a user equipment (UE) may truncate a measurement report, triggered by a satisfaction of a set of triggering conditions associated with LTM, in accordance with at least one of an event-wise truncation or a content-wise truncation. In accordance with the event-wise truncation, the UE may include, within the measurement report, parameters associated with a subset of triggering events of the set of satisfied triggering events. In accordance with the content-wise truncation, the UE may include, within the measurement report, a subset of a larger set of parameters associated with at least one triggering event of the set of satisfied triggering events.

### CROSS REFERENCE

The present Application for Patent claims priority to U.S. Provisional Patent Application No. 63/754,363 by Sung et al., entitled “TRUNCATED EVENT-TRIGGERED MEASUREMENT REPORT DESIGNS AND PROCEDURES IN LOWER-LAYER TRIGGERED MOBILITY,” filed Feb. 5, 2025, which is assigned to the assignee hereof, and is expressly incorporated by reference herein.

### FIELD OF TECHNOLOGY

The following relates to wireless communications, including truncated event-triggered measurement report designs and procedures in lower-layer triggered mobility (LTM).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may support beamforming and perform directional communication (e.g., directional transmission or directional reception, or both) with one or more base stations. In some examples, the UE may measure one or more beams of various cells to determine with which cell to communicate using which beam. In some of such examples, the UE may support lower-layer triggered mobility (LTM), which may enable the UE to switch from one cell or beam to another cell or beam via Layer 1 (L1) or Layer 2 (L2) signaling. For example, the UE may use beam measurements to select a candidate cell or beam or to select a target cell or beam.

### SUMMARY

The systems, methods, and devices of this disclosure each have several innovative aspects, no single one of which is solely responsible for the desirable attributes disclosed herein.

A user equipment (UE) for wireless communications is described. The UE may include one or more memories storing processor executable code, and one or more processors coupled with the one or more memories. The one or more processors may individually or collectively be operable to execute the code to cause the UE to receive a control message that indicates an uplink shared channel resource allocation for measurement reporting associated with a lower-layer triggered mobility (LTM) procedure and transmit, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

A method for wireless communications by a UE is described. The method may include receiving a control message that indicates an uplink shared channel resource allocation for measurement reporting associated with an LTM procedure and transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

Another UE for wireless communications is described. The UE may include means for receiving a control message that indicates an uplink shared channel resource allocation for measurement reporting associated with an LTM procedure and means for transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

Some examples of the method, UEs, and non-transitory computer-readable medium described herein may further include operations, features, means, or instructions for receiving one or more downlink signals associated with at least one of a serving cell or one or more candidate cells, where the satisfaction of the set of triggering events associated with the LTM procedure may be based on a measurement of the one or more downlink signals.

In some examples of the method, UEs, and non-transitory computer-readable medium described herein, the measurement report may be truncated in accordance with the event-wise truncation and the subset of triggering events includes one or more relatively higher priority triggering events as compared to a remainder of the set of triggering events.

In some examples of the method, UEs, and non-transitory computer-readable medium described herein, the measurement report may be truncated in accordance with the content-wise truncation and the subset of parameters includes one or more relatively higher priority parameters as compared to a remainder of the set of parameters associated with the triggering event.

In some examples of the method, UEs, and non-transitory computer-readable medium described herein, the measurement report may be truncated in accordance with a sequence of the event-wise truncation and the content-wise truncation and the sequence defines to initially truncate the measurement report according to the event-wise truncation and to subsequently further truncate the measurement report according to the content-wise truncation in accordance with a size of an event-wise truncated measurement report exceeding the uplink resource within the uplink shared channel resource allocation that may be available for the measurement report.

In some examples of the method, UEs, and non-transitory computer-readable medium described herein, the measurement report may be truncated in accordance with a sequence of the event-wise truncation and the content-wise truncation and the sequence defines to initially truncate the measurement report according to the content-wise truncation and to subsequently further truncate the measurement report according to the event-wise truncation in accordance with a size of a content-wise truncated measurement report exceeding the uplink resource within the uplink shared channel resource allocation that may be available for the measurement report.

Details of one or more implementations of the subject matter described in this disclosure are set forth in the accompanying drawings and the description below. Other features, aspects, and implementations will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports truncated event-triggered measurement report designs and procedures in lower-layer triggered mobility (LTM) in accordance with one or more aspects of the present disclosure.

FIG. 2 shows an example of a signaling diagram that supports truncated event-triggered measurement report designs and procedures in LTM in accordance with one or more aspects of the present disclosure.

FIG. 3 shows an example of a measurement reporting diagram that supports truncated event-triggered measurement report designs and procedures in LTM in accordance with one or more aspects of the present disclosure.

FIGS. 4A and 4B show examples of an event-wise truncation and a content-wise truncation, respectively, that support truncated event-triggered measurement report designs and procedures in LTM in accordance with one or more aspects of the present disclosure.

FIG. 5 shows examples of truncation realizations that support truncated event-triggered measurement report designs and procedures in LTM in accordance with one or more aspects of the present disclosure.

FIG. 6 shows an example of a communication timeline that supports truncated event-triggered measurement report designs and procedures in LTM in accordance with one or more aspects of the present disclosure.

FIG. 7 shows an example of a process flow that supports truncated event-triggered measurement report designs and procedures in LTM in accordance with one or more aspects of the present disclosure.

FIGS. 8 and 9 show block diagrams of devices that support truncated event-triggered measurement report designs and procedures in LTM in accordance with one or more aspects of the present disclosure.

FIG. 10 shows a block diagram of a communications manager that supports truncated event-triggered measurement report designs and procedures in LTM in accordance with one or more aspects of the present disclosure.

FIG. 11 shows a diagram of a system including a device that supports truncated event-triggered measurement report designs and procedures in LTM in accordance with one or more aspects of the present disclosure.

FIG. 12-15 show flowcharts illustrating methods that support truncated event-triggered measurement report designs and procedures in LTM in accordance with one or more aspects of the present disclosure.

### DETAILED DESCRIPTION

In some wireless communications systems, a user equipment (UE) may support lower-layer triggered mobility (LTM), which may enable the UE to switch from one cell or beam to another cell or beam via Layer 1 (L1) or Layer 2 (L2) signaling. As part of an LTM procedure, a UE may perform one or more measurements (e.g., L1 reference signal measurements) and transmit a measurement report to a network entity. In some cases, the UE may transmit the measurement report in an event-triggered manner, such that the measurement report may be understood as an event-triggered measurement report (e.g., an event-triggered L1 measurement report, which the UE may transmit via L2 signaling). The measurement report may include information indicative of an event that triggered the measurement report and may include parameters associated with the event. Such a triggering event may be a beam of a serving cell becoming worse than an absolute threshold or a beam of a candidate cell becoming a threshold amount better (e.g., in terms of signal strength or quality) than a beam of a serving cell, among other examples. In some cases, the UE may include, within the measurement report, information indicative of multiple triggering events and respective sets of parameters associated with each of the multiple triggering events. The UE may transmit the measurement report via an uplink resource within a physical uplink shared channel (PUSCH) resource allocation.

In some scenarios, the uplink resource available for the measurement report may be insufficient to carry a complete, non-truncated version of the measurement report. In such scenarios, the UE may delay the transmission of the measurement report (e.g., to wait for a larger uplink resource) or truncate the measurement report (e.g., to provide a partial report within the currently allocated uplink resource). In cases in which the UE delays the measurement report, the UE may remain in a state of relatively poor signal strength or quality for a longer duration, which may increase the likelihood of communication failures at the UE. In cases in which the UE truncates the measurement report, synchronization issues with the network entity may arise, as the network entity may be unaware of how the UE truncates the measurement report (and unaware of what the UE does with the truncated/omitted information) due to some systems lacking a defined truncation mechanism for LTM measurement reports. Further, truncation mechanisms for other types of uplink reports, such as for buffer status reports (BSRs) or beam failure recovery (BFR) reports, may rely on a truncation rule according to which one or more octets are omitted on an octet-level basis, which may lead to inefficiencies in measurement reporting for LTM. Thus, some systems may benefit from additional mechanisms according to which a UE may truncate an LTM measurement report.

Various aspects relate generally to truncated event-triggered measurement report designs and procedures in LTM. Some aspects more specifically relate to one or more signaling-or configuration-based mechanisms according to which a UE may truncate a measurement report associated with LTM in accordance with at least one of an event-wise truncation or a content-wise truncation. In accordance with the event-wise truncation, the UE may include, within the measurement report, parameters associated with a subset of triggering events of a larger set of triggering events. For example, the UE may transmit the measurement report in accordance with a satisfaction of a set of triggering events and may include, within the measurement report, parameters associated with a subset of the set of satisfied triggering events in accordance with the event-wise truncation (such that at least one satisfied triggering event and its associated parameters are omitted from the measurement report). In accordance with the content-wise truncation, the UE may include, within the measurement report, a subset of parameters of a larger set of parameters associated with a triggering event of the set of satisfied triggering events. For example, for at least one triggering event of the set of satisfied triggering events, the UE may include a subset of a set of parameters associated with that triggering event (such that at least one parameter associated with that triggering event is omitted from the measurement report). As used herein, a “set” may generally refer to a group of one or more, depending on the context. A “subset” also may refer to a group of one or more, with the group including fewer members than a larger set. In other words, in examples in which there is a “subset of a set,” the “set” may refer to a first group of two or more and the “subset” may refer to a second group of one or more, with the first group being larger than and fully including the second group.

In some implementations, by truncating a measurement report associated with an LTM procedure in accordance with the event-wise truncation, a UE may provide parameters associated with select (e.g., higher priority) triggering events within the measurement report with lower latency, which may facilitate low latency mobility at the UE associated with one or more of the select triggering events. Further, by truncating a measurement report associated with an LTM procedure in accordance with the content-wise truncation, a UE may provide at least some parameters associated with a relatively greater quantity of satisfied triggering events within the measurement report with lower latency, which may enable the network entity to obtain a more complete understanding of the triggering events experienced by the UE. In accordance with obtaining a more complete understanding of the triggering events experienced by the UE, the network entity may provide a relatively more suitable communication configuration to the UE, such as by configuring a handover (from one cell or beam to another) at the UE or by configuring one or more other directional beams toward the UE. In accordance with lower latency mobility or more suitable communication configurations, the UE may transition from a state of relatively poor signal strength or quality to a state of relatively greater signal strength or quality in less time, which may increase the reliability of communication to and from the UE. In accordance with more reliable communication, the UE may experience higher data rates and greater spectral efficiency, among other benefits.

Aspects of the disclosure are initially described in the context of wireless communications systems. Additionally, aspects of the disclosure are further illustrated by and described with reference to a signaling diagram, a measurement reporting diagram, an event-wise truncation, a content-wise truncation, truncation realizations, a communication timeline, and a process flow. Aspects of the disclosure are further illustrated by and described with reference to apparatus diagrams, system diagrams, and flowcharts that relate to truncated event-triggered measurement report designs and procedures in LTM.

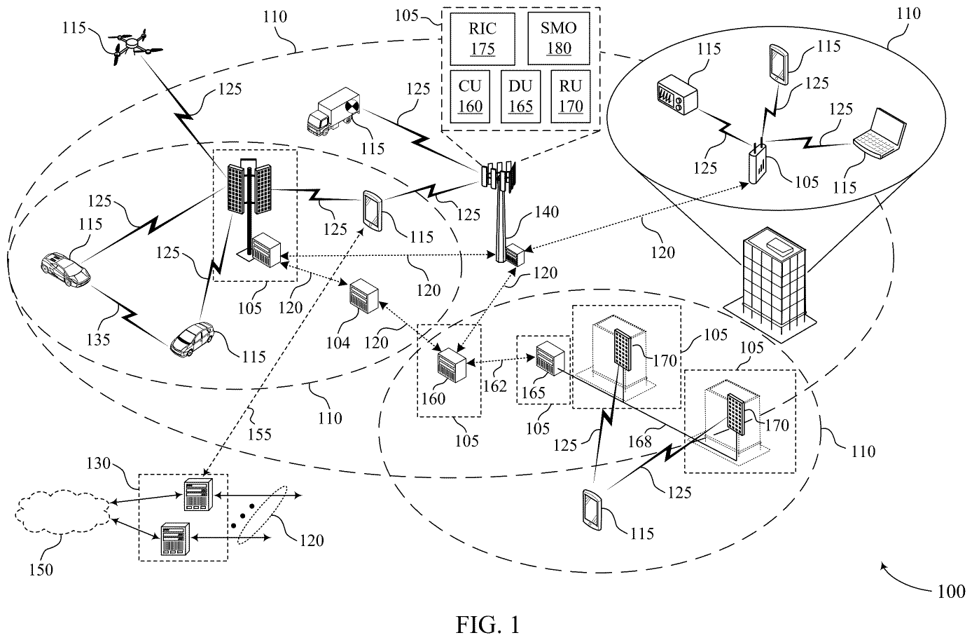

FIG. 1 shows an example of a wireless communications system 100 that supports truncated event-triggered measurement report designs and procedures in LTM in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support truncated event-triggered measurement report designs and procedures in LTM as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may support L1 event-triggered (e.g., event-driven) measurement reports for LTM (e.g., for or associated with an LTM procedure). In such examples, the wireless communications system 100 may support measurement related protocols to support LTM, which may include measurement related protocols applicable to intra-CU master cell group (MCG)/secondary cell group (SCG) LTM and inter-CU MCG/SCG LTM, and which may specify or define components to support event-triggered L1 measurement reporting. In some examples, the measurement related protocols to support LTM may include protocols to support for CSI-RS measurements for LTM procedures or protocols to enable CSI-RS based beam management, or both. Additionally, or alternatively, the measurement related protocols to support LTM may include protocols to specify or define CSI acquisition on one or more candidate cells based on one or more CSI-RSs before or during an LTM cell switch. In some systems, a UE 115 and a network entity 105 may support a CSI report before or during the LTM cell switch as part of the CSI acquisition procedure. In some other systems, a UE 115 and a network entity 105 may not support a CSI report before or during the LTM cell switch as part of the CSI acquisition procedure.

In some examples, event-triggered L1 measurement may be designed for LTM to select a candidate beam or cell to trigger early synchronization or to select a target beam or cell and trigger an LTM cell switch procedure, or both. An LTM procedure may be or include a synchronization procedure, a cell switch procedure, a beam switch procedure, a handover procedure, or any combination thereof. For some event-triggered L1 measurements, a UE 115 may use one or more beam-level measurement results for event evaluation (e.g., to determine whether a triggering event is satisfied, such as to determine whether an event triggers a measurement report). A UE 115 may support one or more triggering events (which also may be understood or referred to as LTM events or L1 LTM measurement events) based on a beam-specific quality of a serving cell or of one or more candidate cells.

A first triggering event may be an event in which a signal quality or strength metric associated with a beam of a serving cell becomes worse than (e.g., lower than) an absolute threshold. A second triggering event may be an event in which a signal quality or strength metric associated with a beam of a candidate cell becomes an amount of offset (e.g., a threshold amount) better than (e.g., greater than) a signal quality or strength metric associated with a beam of a serving cell. A third triggering event may be an event in which a signal quality or strength metric associated with a beam of a candidate cell becomes better than (e.g., greater than) an absolute threshold. A fourth triggering event may be an event in which a signal quality or strength metric associated with a beam of a serving cell becomes worse than (e.g., lower than) a first absolute threshold and in which a signal quality or strength metric associated with a beam of a candidate cell becomes better than (e.g., greater than) a second absolute threshold. The first absolute threshold and the second absolute threshold may be the same or different.

To determine (e.g., evaluate) whether a triggering event is satisfied, a UE 115 may support (e.g., use) a beam configuration of SSB or CSI-RS in L1 measurement resource configuration in an LTM configuration. In other words, the UE 115 may measure beams associated with (e.g., used to transmit) one or more SSBs or one or more CSI-RSs to evaluate whether a triggering event is satisfied. In some examples, the UE 115 may use a same reference signal type (e.g., SSB or CSI-RS) for both a serving cell and a neighboring (e.g., candidate) cell when evaluating whether the second triggering event or the fourth triggering event is satisfied. In some examples, the UE 115 may filter the L1 measurement results. The UE 115 may filter the L1 measurement results in accordance with a specified L1 filter (e.g., defined by a network specification) or in accordance with an L1 filter (autonomously) selected by the UE 115 (e.g., in accordance with an autonomous or independent UE decision). For LTM event evaluation, a UE 115 may apply a time-to-trigger (TTT), a hysteresis for entering/leaving, or a beam specific or cell specific offset. In some examples, the UE 115 may perform measurement reporting (e.g., transmit a measurement report) in accordance with a satisfaction of a leaving condition. In some other examples, the UE 115 may not perform measurement reporting in accordance with a satisfaction of a leaving condition.

In some examples, a UE 115 may evaluate a TTT per beam and may (only) transmit a measurement report when triggered by a beam that has satisfied a condition (for entering or leaving) for a full (e.g., whole or complete) duration of the TTT. In some examples, a UE 115 may not restart a TTT timer if a current beam changes and an entering condition is still met with the new current beam. In some examples, a UE 115 may apply TTT to a leaving condition. In some examples, a network entity 105 may configure (e.g., via RRC signaling, such as via one or more RRC information elements) which reference signal type (e.g., SSB or CSI-RS) is used by a UE 115 for an LTM event evaluation. In some examples, either a CSI-RS or an SSB may be configured as a candidate beam and the measurement reference signal of the serving cell beam may be determined based on the candidate beam to facilitate use of the same reference signal type. For example, a reference signal for a current beam of a serving cell may be the same as or quasi-colocated with a quasi-colocation (QCL) reference signal of an indicated transmission configuration indicator (TCI) state.

In some examples, an SSB resource indicator (SSBRI) or a CSI-RS resource indicator (CRI) may be used to represent a candidate beam identifier (ID) in an LTM measurement report, which may be an LTM measurement report MAC control element (MAC-CE). In some examples, for event-triggered L1 LTM measurement reporting, a UE 115 may include up to N beams within the measurement report. In other words, an upper limit of N may be a total quantity of all beams included within the measurement report. In some examples, for event-triggered L1 LTM measurement reporting, a network entity 105 may control whether the beam(s) not satisfying a triggering event can be reported (e.g., according to the N beams within the measurement report). A beam being included within a measurement report may be understood as a UE 115 indicating, via the measurement report, an ID of the beam, one or more parameters (e.g., one or more signal strength or quality metrics) associated with the beam, or both. In some examples, a UE 115 may use a single MAC-CE format for the event-triggered L1 measurement report for both SSB and CSI-RS reference signals. In some examples, a UE 115 may support a truncated measurement report MAC-CE.

In some examples, a UE 115 may additionally support one or more other truncated MAC-CEs. For example, a UE 115 may support a truncated BSR MAC-CE. A UE 115 may use a truncated BSR MAC-CE in scenarios in which the BSR is a padding BSR and in scenarios in which a quantity of padding bits is larger than or equal to a short BSR MAC-CE plus a sub-header but smaller than a long BSR MAC-CE plus the sub-header. In some examples, a UE 115 may report a subset of data availability of a logical channel group (LCG) based on a logical channel priority. In such examples, the UE 115 may include as many buffer size fields as possible to reach an upper limit of padding bit utilization and may truncate (e.g., exclude) one or more buffer size fields that are unable to fit within the available padding bits. A buffer size field may be equal to one octet in size, such that the truncation for the BSR MAC-CE is on an octet-level basis. A truncation of a MAC-CE on an octet-level basis may refer to how a truncated version of the MAC-CE includes an integer quantity of octets and does not include a partial octet.

By way of further example, a UE 115 may support a truncated BFR MAC-CE. A UE 115 may use a truncated BFR MAC-CE in scenarios in which a PUSCH allocation is insufficient to accommodate the BFR MAC-CE plus a sub-header. In some examples, a quantity of C octets within the BFR MAC-CE may be further reduced from 4 to 1, such as in examples in which a four-octet bitmap is not accommodated. In such examples, the UE 115 may attempt to include an upper limit quantity of octets including an ‘AC’ field (e.g., a field indicating that a candidate reference signal ID field is present within the same octet) within the BFR MAC-CE. For a truncated enhanced BFR MAC-CE, an ‘S’ field may be added (e.g., included) to distinguish serving cells with two beam failure detection (BFD) reference signal (BFD-RS) sets. Otherwise, the same principle of truncated BFR MAC-CE may be applied to the truncated enhanced BFR MAC-CE. For example, the truncation of the BFR MAC-CE and of the enhanced BFR MAC-CE is also on an octet-level basis.

In other words, some truncated MAC-CEs for BSR and (enhanced) BFR may have (e.g., use or otherwise be associated with) a truncation rule according to which one or more of single octets (“buffer size” for BSR, and “AC+ID+reference signal ID” for (enhanced) BFR) may be omitted in scenarios in which a PUSCH allocation is insufficient to accommodate the entire MAC-CE. For a truncated event-triggered L1 measurement report MAC-CE, however, a truncation rule may be further defined to use a ‘sub-octet’ level of truncation, which may increase an amount of information a serving cell may receive via the truncated event-triggered L1 measurement report MAC-CE. By increasing the amount of information the serving cell may receive via the truncated event-triggered L1 measurement report MAC-CE, the serving cell may react faster (e.g., trigging an aperiodic CSI report for a full-fledged, such as complete, report or an LTM cell switch) even with the limited report information. Accordingly, various aspects of the subject matter disclosed herein support a truncation rule that is (uniquely or exclusively) defined for a truncated event-triggered L1 measurement report for LTM. In accordance with such aspects, a measurement report may be truncated at a ‘sub-octet’ level of truncation, such that the measurement report may include a partial octet. Additionally, some further aspects relate to corresponding action or behavior at a UE 115 after transmission of a truncated event-triggered L1 measurement report, such as action or behavior pertaining to how the UE 115 manages truncated information.

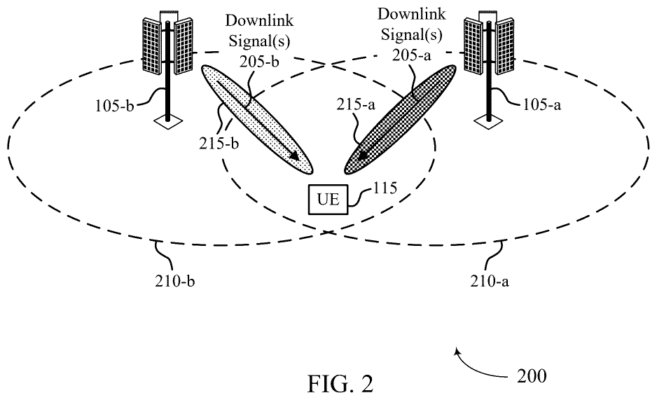

FIG. 2 shows an example of a signaling diagram 200 that supports truncated event-triggered measurement report designs and procedures in LTM in accordance with one or more aspects of the present disclosure. The signaling diagram 200 illustrates communication between a UE 115, a network entity 105-a, and a network entity 105-b, which may be examples of corresponding devices as illustrated and described herein. In some aspects, the signaling diagram 200 illustrates an example scenario in which the UE 115 receives downlink signals (e.g., data signals or reference signals, or both) from, via, or on one or more cells using or otherwise in association with one or more beams.

In some examples, the UE 115 may receive one or more downlink signals 205-a associated with a cell 210-a and may perform one or more measurements (e.g., L1 signal strength or quality measurements) of the one or more downlink signals 205-a. In some examples, the UE 115 may measure the one or more downlink signals 205-a using or otherwise in association with a beam 215-a. The beam 215-a may be a directional communication beam used by the network entity 105-a to transmit the one or more downlink signals 205-a or used by the UE 115 to receive the one or more downlink signals 205-a. The one or more measurements may include one or more reference signal receive power (RSRP) measurements, one or more reference signal receive quality (RSRQ) measurements, one or more signal-to-noise ratio (SNR) measurements, one or more signal-to-interference-plus-noise ratio (SINR) measurements, one or more channel quality indicator (CQI) measurements, or any combination thereof.

Additionally, or alternatively, the UE 115 may receive one or more downlink signals 205-b associated with a cell 210-b and may perform one or more measurements (e.g., L1 signal strength or quality measurements) of the one or more downlink signals 205-b. In some examples, the UE 115 may measure the one or more downlink signals 205-b using or otherwise in association with a beam 215-b. The beam 215-b may be a directional communication beam used by the network entity 105-b to transmit the one or more downlink signals 205-b or used by the UE 115 to receive the one or more downlink signals 205-b. The one or more measurements may include one or more RSRP measurements, one or more RSRQ measurements, one or more SNR measurements, one or more SINR measurements, one or more CQI measurements, or any combination thereof. Although illustrated in the example of the signaling diagram 200 as being associated with different network entities 105 (e.g., the network entity 105-a and the network entity 105-b), the cell 210-a and the cell 210-b may alternatively be associated with a same network entity 105.

In some examples, the UE 115 may perform the one or more L1 measurements associated with the one or more downlink signals 205-a or the one or more downlink signals 205-b, or any combination thereof, as part of an LTM procedure. For example, the cell 210-a may be an example of a serving cell, and the cell 210-b may be an example of a candidate or neighbor cell. In such examples, the beam 215-a may be a beam of a serving cell and the beam 215-b may be a beam of a candidate cell, either or both of which the UE 115 may measure to determine whether one or more triggering events associated with the LTM procedure are satisfied. In examples in which at least one triggering event associated with the LTM procedure is satisfied, the UE 115 may transmit a measurement report, which may be understood as an event-triggered L1 measurement report. In some implementations, the UE 115 may truncate the measurement report prior to transmitting the measurement report.

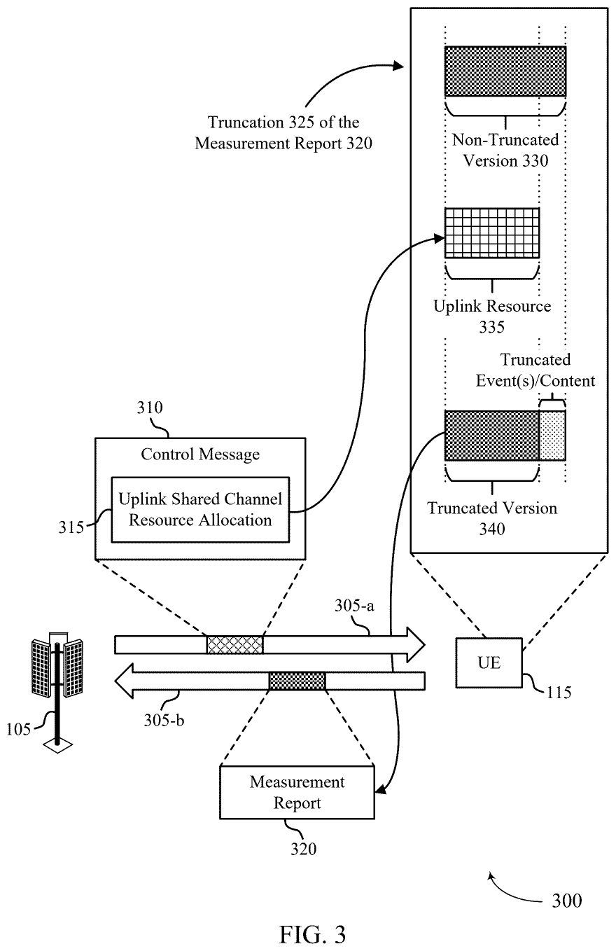

FIG. 3 shows an example of a measurement reporting diagram 300 that supports truncated event-triggered measurement report designs and procedures in LTM in accordance with one or more aspects of the present disclosure. The measurement reporting diagram 300 illustrates communication between a UE 115 and a network entity 105, which may be examples of corresponding devices as illustrated and described herein. For example, the UE 115 and the network entity 105 may communicate via a downlink 305-a and an uplink 305-b. In accordance with the measurement reporting diagram 300, the UE 115 may transmit a truncated measurement report (e.g., a truncated event-triggered L1 measurement report MAC-CE) when a regular measurement report (e.g., a complete or non-truncated event-triggered L1 measurement report MAC-CE) plus a sub-header cannot be accommodated within an amount of allocated data (e.g., an amount of allocated resources).

For example, the UE 115 may receive, from the network entity 105, a control message 310 that indicates an uplink shared channel resource allocation 315. The uplink shared channel resource allocation 315 may be a PUSCH resource allocation and may be indicated via one or more frequency domain resources or one or more time domain resources, or both. In some examples, the uplink shared channel resource allocation 315 may be associated with an LTM procedure. Additionally, or alternatively, the uplink shared channel resource allocation 315 may be allocated to the UE 115 for another purpose and the UE 115 may use a portion of the uplink shared channel resource allocation 315 for LTM-associated measurement reporting. In accordance with receiving the indication of the uplink shared channel resource allocation 315 and in accordance with a satisfaction of a set of triggering events associated with the LTM procedure, the UE 115 may transmit a measurement report 320 via an uplink resource 335 within the uplink shared channel resource allocation 315. The uplink resource 335 may include all or a subset of resources within the uplink shared channel resource allocation 315.

In some implementations, the uplink resource 335 available for the measurement report 320 may be insufficient to carry a non-truncated version 330 of the measurement report 320. In such implementations, the UE 115 may perform a truncation 325 of the measurement report 320 to exclude (e.g., to truncate or omit) some information from the non-truncated version 330 that would exceed the uplink resource 335 that is available for the measurement report 320. In accordance with performing the truncation 325 of the measurement report 320, the UE 115 may obtain, generate, select, identify, or otherwise determine a truncated version 340 of the measurement report 320. The measurement report 320 that the UE 115 transmits to the network entity 105 via the uplink resource 335 may be the truncated version 340 of the measurement report 320.

In addition to truncating the measurement report 320 in accordance with the uplink resource 335 being insufficient to carry the non-truncated version 330 of the measurement report, the UE 115 may be configured (such as via RRC signaling from the network entity 105) to perform the truncation 325 of the measurement report 320 even in scenarios in which the non-truncated version 330 of the measurement report 320 is eligible for transmission (e.g., in scenarios in which the uplink resource 335 is sufficient to carry the non-truncated version 330 of the measurement report 320). For example, the UE 115 may receive information indicative of a condition associated with transmission of uplink reports by the UE 115 and the condition may define (e.g., request or instruct) the UE 115 to transmit a truncated uplink report to provide sufficient resources, within the uplink shared channel resource allocation 315 or the uplink resource 335, for transmission of at least a lower limit quantity of other uplink reports or at least a lower limit amount of uplink data. In other words, the network entity 105 may configure the UE 115 with such a condition to enable other, relatively lower priority MAC-CE(s) or uplink shared channel data (other than the event-triggered L1 measurement report associated with LTM) to still be transmitted along with the measurement report 320 (e.g., without being dropped).

The UE 115 may receive the information indicative of the condition from the network entity 105 via RRC signaling, such as via an RRC configuration. In some examples, the RRC configuration may include a single-bit indicator or a multi-bit indicator that is associated with (e.g., indicative of) a lower limit quantity of lower priority MAC-CEs, one or more types of the lower priority MAC-CEs, a lower limit quantity of uplink shared data messages, a lower limit amount of uplink data, or any combination thereof. The condition may be applicable to any uplink reports (that support truncation) transmitted by the UE 115, such as for other uplink reports (that support truncation) in addition to the measurement report 320.

The UE 115 may perform the truncation 325 of the measurement report 320 in or at one or more different levels of truncation. For example, the UE 115 may perform the truncation 325 of the measurement report 320 in or at two different levels of truncation including an event-wise truncation or a content-wise truncation. In such examples, the UE 115 may perform the truncation 325 of the measurement report 320 in accordance with the event-wise truncation, the content-wise truncation, or both. In accordance with performing the truncation 325 of the measurement report 320 in accordance with the event-wise truncation, the content-wise truncation, or both, the UE 115 may achieve, enable, or facilitate lower latency measurement reporting associated with LTM, which may result in the UE 115 realizing a higher signal strength or quality in a shorter amount of time as compared to, for example, if the UE 115 delayed transmission of the measurement report 320 until sufficient resources for a complete (e.g., full-fledged) measurement report become available.

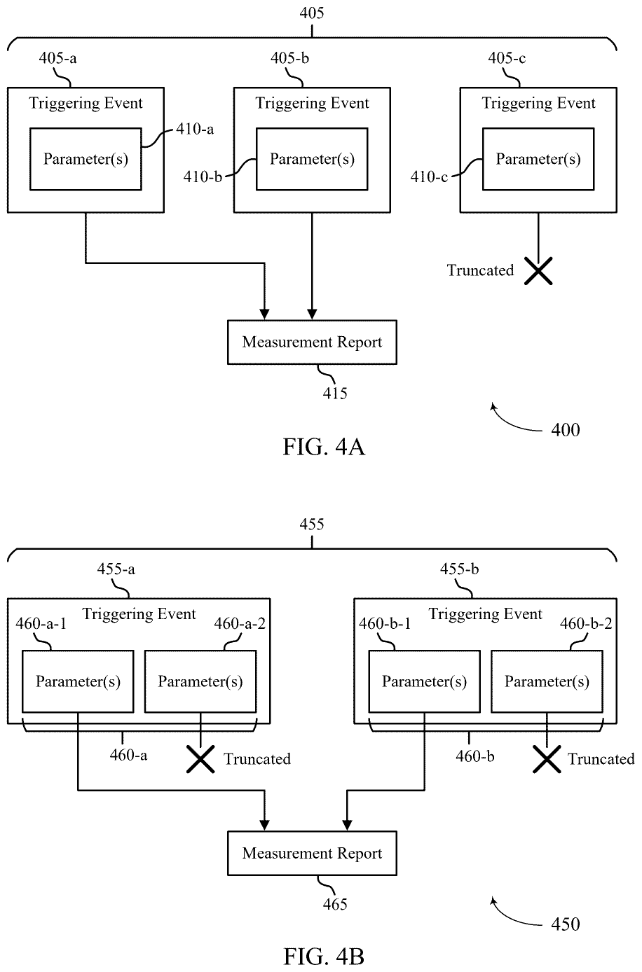

FIGS. 4A and 4B show examples of an event-wise truncation 400 and a content-wise truncation 450, respectively, that support truncated event-triggered measurement report designs and procedures in LTM in accordance with one or more aspects of the present disclosure. For example, a UE 115 may perform the event-wise truncation 400, the content-wise truncation 450, or both as part of performing the truncation 325 of the measurement report 320, as illustrated by and described with reference to FIG. 3. The UE 115 may perform the event-wise truncation 400 or the content-wise truncation 450, or both, in accordance with a satisfaction of a set of (one or more) triggering events associated with an LTM procedure and in accordance with an uplink resource available for a measurement report being insufficient to accommodate a non-truncated version of the measurement report or some other condition.

In the example of the event-wise truncation 400, the set of triggering events associated with the LTM procedure that are satisfied may include a set of triggering events 405. The set of triggering events 405 may include a triggering event 405-a, a triggering event 405-b, and a triggering event 405-c. Although the set of triggering events 405 is illustrated and described as including three triggering events, the set of triggering events 405 may include any quantity of triggering events without exceeding the scope of the present disclosure. Each triggering event of the set of triggering events 405 may be associated with a respective set of parameters. Each respective set of parameters may include or indicate a triggering event ID, a triggering event type, one or more triggered beam IDs, one or more triggered beam measurement results, one or more non-triggered beam IDs, one or more non-triggered beam measurement results, or any combination thereof. Measurement results may include one or more RSRP metrics, one or more RSRQ metrics, one or more SNR metrics, one or more SINR metrics, one or more CQI metrics, or any combination thereof. The triggering event 405-a may be associated with one or more parameters 410-a, the triggering event 405-b may be associated with one or more parameters 410-b, and the triggering event 405-c may be associated with one or more parameters 410-c.

In accordance with the event-wise truncation 400, the UE 115 may include, within a measurement report 415, one or more parameters associated with a subset of triggering events of the set of triggering events 405. In other words, for the event-wise truncation 400, more than one triggering event may have fulfilled the event condition (e.g., been satisfied) and an allocation data size may be insufficient to carry all the triggering events (which also may be understood or referred to as triggered events) within the measurement report 415. The more than one triggering event with the fulfilled event condition may include newly triggered events or previously triggered events that were not reported via a previous measurement report due to a truncation or prioritization rule, or both. In some examples, the subset of triggering events may include the triggering event 405-a and the triggering event 405-b and may exclude the triggering event 405-c. In such examples, the UE 115 may include, within the measurement report 415, the one or more parameters 410-a associated with the triggering event 405-a and the one or more parameters 410-b associated with the triggering event 405-b. The UE 115 may exclude, from the measurement report 415, the one or more parameters 410-c associated with the triggering event 405-c.

In some examples, the UE 115 may define or apply a priority among the set of triggering events 405 to determine which triggering events of the set of triggering events 405 to include within the measurement report 415. For example, the triggering event 405-a and the triggering event 405-b may be associated with relatively higher priorities than the triggering event 405-c. In other words, the triggering event 405-a and the triggering event 405-b may be relatively higher priority triggering events as compared to a remainder of the set of triggering events 405 (e.g., the triggering event 405-c). The UE 115 may receive information indicative of, select, or otherwise employ one or more prioritization rules, which the UE 115 may use to select triggering events for inclusion within the measurement report 415 independently or in any combination.

In some implementations, each triggering event may be associated with an RRC configured priority (e.g., each event configuration may be associated with a priority value). In such implementations, the UE 115 may receive (e.g., via RRC signaling, such as via one or more RRC information elements) information indicative of a respective priority associated with each triggering event configuration of a set of triggering event configurations. The triggering event 405-a and the triggering event 405-b may be associated with one or more triggering event configurations associated with relatively higher priorities as compared to a triggering event configuration associated with the triggering event 405-c.

Additionally, or alternatively, the UE 115 may employ an event type-based prioritization. In such implementations, different LTM triggering events may be associated with different priorities. For example, the first triggering event may have a higher priority than other types of triggering events. The triggering event 405-a and the triggering event 405-b may be associated with one or more triggering event types that are associated with relatively higher priorities as compared to a triggering event type associated with the triggering event 405-c.

Additionally, or alternatively, the UE 115 may employ an event ID (network configured)-based prioritization. In some of such implementations, a lower event ID may have a relatively higher priority as compared to a higher event ID. Alternatively, in some other of such implementations, a higher event ID may have a relatively higher priority as compared to a lower event ID. The UE 115 may receive information indicative of a triggering event ID associated with each triggering event of the set of triggering events 405, each triggering event ID associated with a respective priority. The triggering event 405-a and the triggering event 405-b may be associated with triggering event IDs that are associated with relatively higher priorities as compared to a triggering event ID associated with the triggering event 405-c.

Additionally, or alternatively, the UE 115 may autonomously, such as in accordance with an autonomous UE decision, prioritize a subset of triggering events, of the set of triggering events 405, for inclusion within the measurement report 415. In such implementations, the UE 115 may autonomously select, identify, or otherwise determine a respective priority associated with each triggering event of the set of triggering events 405. The triggering event 405-a and the triggering event 405-b may be associated with relatively higher UE-selected priorities as compared to the triggering event 405-c.

In the example of the content-wise truncation 450, the set of triggering events associated with the LTM procedure that are satisfied may include a set of triggering events 455. The set of triggering events 455 may include a triggering event 455-a and a triggering event 455-b. Although the set of triggering events 455 is illustrated and described as including two triggering events, the set of triggering events 455 may include any quantity of triggering events without exceeding the scope of the present disclosure. Each triggering event of the set of triggering events 455 may be associated with a respective set of parameters. Each respective set of parameters may include or indicate a triggering event ID, a triggering event type, one or more triggered beam IDs, one or more triggered beam measurement results, one or more non-triggered beam IDs, one or more non-triggered beam measurement results, or any combination thereof. Measurement results may include one or more RSRP metrics, one or more RSRQ metrics, one or more SNR metrics, one or more SINR metrics, one or more CQI metrics, or any combination thereof. The triggering event 455-a may be associated with a set of parameters 460-a and the triggering event 455-b may be associated with a set of parameters 460-b.

In accordance with the content-wise truncation 450, the UE 115 may include, within a measurement report 465, a subset of parameters of a set of parameters associated with at least one triggering event of the set of triggering events 455. In other words, for a triggering event, in scenarios in which the allocated data size is insufficient to carry a full measurement report for that triggering event, the UE 115 may perform the content-wise truncation 450. For example, for the triggering event 455-a, the UE 115 may include, within the measurement report 465, a first subset of parameters 460-a-1 of the set of parameters 460-a and may exclude, from the measurement report 465, a second subset of parameters 460-a-2 of the set of parameters 460-a. By way of further example, for the triggering event 455-b, the UE 115 may include, within the measurement report 465, a first subset of parameters 460-b-1 of the set of parameters 460-b and may exclude, from the measurement report 465, a second subset of parameters 460-b-2 of the set of parameters 460-b.

In some examples, to inform a network entity 105 of a triggering event and its report in a timely and mutually understood manner, the UE 115 may receive information indicative of, select (e.g., in accordance with a network specification), or otherwise employ a prioritization rule, which the UE 115 may use to select parameters for inclusion within the measurement report 465. For example, the UE 115 may apply the prioritization rule to report parameters (e.g., the set of parameters 460-a and the set of parameters 460-b) such that one or more parameters associated with relatively higher priorities are included within the measurement report 465 (e.g., such that an upper limit of relatively higher priority parameters are indicated via the allocated data). In some implementations, the prioritization rule may define or indicate a respective priority associated with each parameter or each parameter group. In other words, a parameter or a parameter group may be associated with an implicit or explicit priority such that higher priority parameters or parameter groups are prioritized for inclusion within the measurement report 465. In such implementations, the first subset of parameters 460-a-1 may be associated with one or more relatively higher priorities as compared to the second subset of parameters 460-a-2. Likewise, the first subset of parameters 460-b-1 may be associated with one or more relatively higher priorities as compared to the second subset of parameters 460-b-2.

An example prioritization rule may define a priority order of (1) triggering event ID or triggering event type, or both, (2) triggered beam ID(s), (3) triggered beam measurement result(s), (4) non-triggered beam ID(s), and (5) non-triggered beam measurement result(s). In accordance with such a prioritization rule, the UE 115 may prioritize a triggering event ID or a triggering event type over triggered beam ID(s), may prioritize triggered beam ID(s) over triggered beam measurement result(s), and so on. For the triggered beam ID(s), the UE 115 may report a current beam or a candidate beam depending on the type of the triggering event. If for a current beam, the UE 115 may omit a beam ID. For triggered beam measurement result(s), the UE 115 may apply different quantization to the measurement results in scenarios in which truncation is performed. For example, the UE 115 may use an X-bit representation for triggered beam measurement results for a non-truncated measurement report and may use a Y-bit representation for triggered beam measurement results for a truncated measurement report. In some examples, X>Y. For example, X=7 and Y=4. For non-triggered beam ID(s), the UE 115 may report a non-current or candidate beam depending on the type of the triggering event. For the non-triggered beam measurement result(s), the UE 115 may apply different quantization to the measurement results in scenarios in which truncation is performed. For example, the UE 115 may use an X′-bit representation for non-triggered beam measurement results for a non-truncated measurement report and may use a Y′-bit representation for non-triggered beam measurement results for a truncated measurement report. In some examples, X′>Y′.

In some implementations, the UE 115 may perform a truncation of multiple triggering events in one or more of various ways, such as in accordance with both the event-wise truncation 400 and the content-wise truncation 450. In such implementations, the UE 115 may truncate a measurement report in accordance with a sequence (e.g., an ordered sequence) of the event-wise truncation 400 and the content-wise truncation 450. The UE 115 may receive information indicative of the sequence from a network entity 105 or may select the sequence (e.g., in accordance with a network specification), or any combination thereof.

In some examples, the sequence may define that the UE 115 performs the event-wise truncation 400 first, followed by the content-wise truncation 450. In such examples, the UE 115 may provide one or more full-fledged (e.g., complete) reports for one or more relatively higher priority triggering events and may provide one or more partial reports (in accordance with the content-wise truncation 450) or completely omit one or more reports (in accordance with the event-wise truncation 400) for one or more relatively lower priority triggering events, or any combination thereof. In some other examples, the sequence may define that the UE 115 performs the content-wise truncation 450 first, followed by the event-wise truncation 400. In such examples, the UE 115 may truncate each triggering event to include relatively higher priority (e.g., critical) information (in accordance with the content-wise truncation 450) and, if a measurement report is still too large to fit within the allocated data, the UE 115 may omit one or more reports associated with one or more relatively lower priority triggering events (in accordance with the event-wise truncation 400).

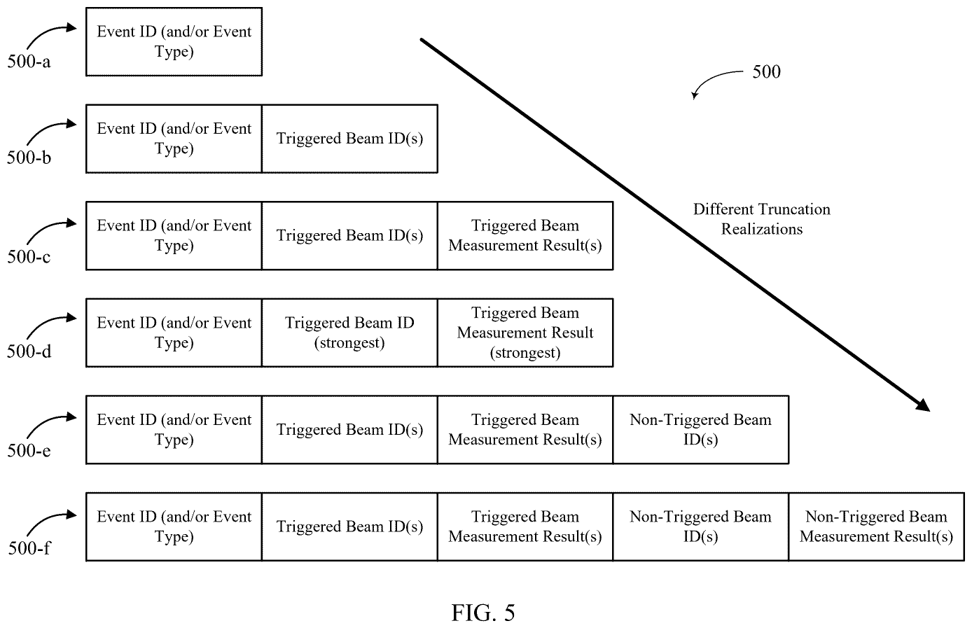

FIG. 5 shows examples of truncation realizations 500 that support truncated event-triggered measurement report designs and procedures in LTM in accordance with one or more aspects of the present disclosure. A UE 115, which may be an example of a corresponding device as illustrated and described herein, may use, select, identify, acquire, or otherwise determine one of the truncation realizations 500 in accordance with performing a truncation of a measurement report (e.g., an event-triggered L1 measurement report) associated with an LTM procedure. For example, the UE 115 may use one of the truncation realizations 500 in accordance with performing a content-wise truncation of the measurement report (such as the content-wise truncation 450 as illustrated by and described with reference to FIG. 4B).

The truncation realizations 500 illustrate different levels of truncation that the UE 115 may perform, with some of the truncation realizations 500 being associated with relatively more truncation and some others of the truncation realizations 500 being associated with relatively less truncation. An amount of truncation that the UE 115 performs may depend on an amount of uplink resources that is available for measurement reporting. For each of the truncation realizations 500, the UE 115 may include the illustrated information (e.g., the denoted parameters) for a triggering event within a measurement report and may exclude a remainder of parameters associated with the triggering event from the measurement report.

In accordance with a truncation realization 500-a, the UE 115 may include, within a measurement report and for a triggering event, an event ID (or a type of the triggering event, or both) associated with the triggering event. In accordance with a truncation realization 500-b, the UE 115 may include, within a measurement report and for a triggering event, an event ID (or a type of the triggering event, or both) associated with the triggering event and one or more triggered beam IDs associated with the triggering event. In accordance with a truncation realization 500-c, the UE 115 may include, within a measurement report and for a triggering event, an event ID (or a type of the triggering event, or both) associated with the triggering event, one or more triggered beam IDs associated with the triggering event, and one or more triggered beam measurement results associated with the one or more triggered beam IDs.

In accordance with a truncation realization 500-d, the UE 115 may include, within a measurement report and for a triggering event, an event ID (or a type of the triggering event, or both) associated with the triggering event, a single (strongest) triggered beam ID associated with the triggering event, and a single (strongest) triggered beam measurement result associated with the single triggered beam ID. In other words, in accordance with the truncation realization 500-d, the UE 115 may include a single strongest beam ID and measurement within the measurement report. In accordance with a truncation realization 500-e, the UE 115 may include, within a measurement report and for a triggering event, an event ID (or a type of the triggering event, or both) associated with the triggering event, one or more triggered beam IDs associated with the triggering event, one or more triggered beam measurement results associated with the one or more triggered beam IDs, and one or more non-triggered beam IDs. In accordance with a truncation realization 500-f, the UE 115 include, within a measurement report and for a triggering event, an event ID (or a type of the triggering event, or both) associated with the triggering event, one or more triggered beam IDs associated with the triggering event, one or more triggered beam measurement results associated with the one or more triggered beam IDs, one or more non-triggered beam IDs, and one or more non-triggered beam measurement results associated with the one or more non-triggered beam IDs.

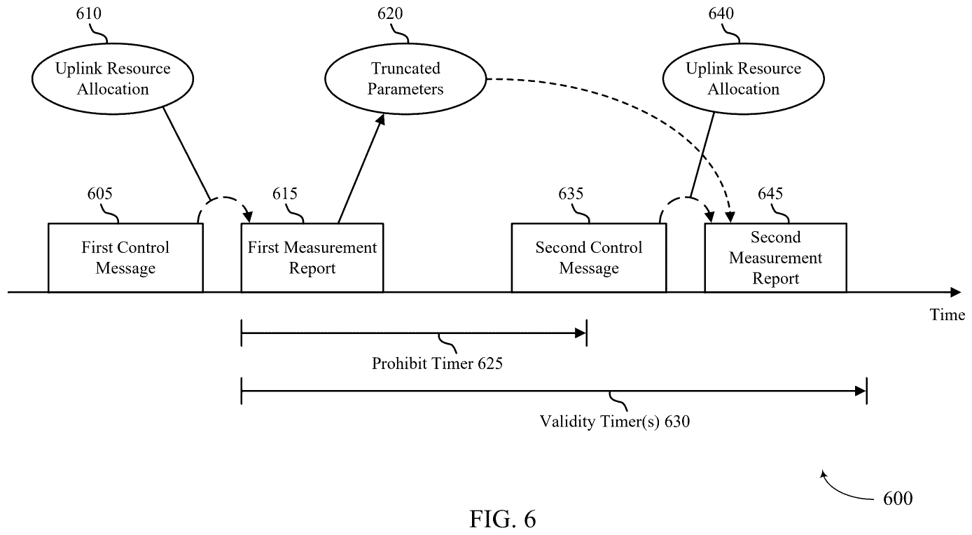

FIG. 6 shows an example of a communication timeline 600 that supports truncated event-triggered measurement report designs and procedures in LTM in accordance with one or more aspects of the present disclosure. A UE 115 and a network entity 105, which may be examples of corresponding devices as illustrated and described herein, may communicate in accordance with the communication timeline 600. In accordance with the communication timeline 600, the UE 115 may keep (e.g., store or maintain, such as in one or more memories) information that is truncated from one measurement report and transmit such previously truncated information via one or more other measurement reports in one or more future PUSCH transmission opportunities (e.g., such that the previously truncated information is provided to the network entity 105 via a delayed transmission).

For example, the UE 115 may receive a first control message 605 indicating an uplink resource allocation 610 via which the UE 115 may transmit a first measurement report 615. In some implementations, the UE 115 may truncate the first measurement report 615 in accordance with at least one of an event-wise truncation (such as the event-wise truncation 400, as illustrated by and described with reference to FIG. 4A) or a content-wise truncation (such as the content-wise truncation 450, as illustrated by and described with reference to FIG. 4B). In accordance with the truncation of the first measurement report 615, the UE 115 may truncate one or more full triggering events or one or more partial triggering events and may keep a set of truncated parameters 620 for transmission in a future PUSCH transmission opportunity. In some examples, a transmission of previously truncated reports (e.g., the truncated parameters 620) may have a relatively higher priority as compared to newly triggered reports associated with new triggering events. In other words, previously truncated events may have a relatively higher priority as compared to newly triggered events. In some aspects, the UE 115 may apply one or more prioritization rules associated with event-wise truncation or content-wise truncation after prioritizing previously truncated events.

In some examples, the UE 115 may support one or more timers associated with truncated reports (e.g., the truncated parameters 620). In some implementations, the one or more timers may include a prohibit timer 625. The prohibit timer 625 may restrict how frequently the UE 115 is able to transmit measurement reports (e.g., event-triggered L1 measurement reports associated with LTM). For example, the prohibit timer 625 may be exclusively or specifically used for restricting a frequency of event-triggered L1 measurement reports associated with LTM. For partially truncated events, the UE 115 may use (e.g., apply) the prohibit timer 625 instead of keeping the truncated report to be transmitted in a subsequent PUSCH transmission opportunity. The UE 115 may start the prohibit timer 625 at a transmission time of the first measurement report 615.

In some examples, the prohibit timer 625 may be relatively shorter than one or more other prohibit timers, such as shorter than a default prohibit timer associated with measurement reporting or shorter than a scheduling request (SR) prohibit timer. In some examples, the UE 115 may determine (e.g., identify, select, or calculate) a duration of the prohibit timer 625 in accordance with a function of how many parameters were truncated from the first measurement report 615. In such examples, the duration of the prohibit timer 625 may be associated with a quantity of the truncated parameters 620. For example, to determine the duration of the prohibit timer 625, the UE 115 may apply a multiplier to a baseline prohibit timer value.

In some examples, each quantity of a set of quantities of truncated parameters may be associated with a respective multiplier. For example, the UE 115 may apply a first multiplier to the baseline prohibit timer value to determine the duration of the prohibit timer 625 in accordance with the truncated parameters 620 including a first quantity of parameters. By way of further example, the UE 115 may apply a second multiplier to the baseline prohibit timer value to determine the duration of the prohibit timer 625 in accordance with the truncated parameters 620 including a second quantity of parameters. The duration of the prohibit timer 625 may decrease as the quantity of the truncated parameters 620 increases. Additionally, or alternatively, a duration of the prohibit timer 625 may be associated with a priority of one or more of the truncated parameters 620. For example, the duration of the prohibit timer 625 may decrease as the priority of one or more of the truncated parameters 620 increases. In accordance with such a prohibit timer 625, the UE 115 may transmit another event-triggered L1 measurement report for the partially truncated event with lower latency due to the incomplete report contents, as compared to a non-truncated event report.

Additionally, or alternatively, the one or more timers may include one or more validity timers 630. The one or more validity timers 630 may be defined for truncated reports (e.g., the truncated parameters 620) and may define an upper limit amount of time, from a transmission time of the first measurement report 615, for which the truncated parameters 620 are still valid or relevant (e.g., useful). Accordingly, the UE 115 may attempt to report the truncated parameters 620 to the network entity 105 prior to expiration of the one or more validity timers 630. In some examples, the one or more validity timers 630 may include a single validity timer common to (e.g., applicable to) each of (e.g., all of) the truncated parameters 620. In some other examples, the one or more validity timers 630 may include multiple validity timers, with each validity timer applicable to a respective one or more of the truncated parameters 620.

In accordance with supporting the one or more validity timers 630, the UE 115 may better manage memory space by selectively storing relevant (e.g., relatively fresh) parameters and removing (from memory) irrelevant (e.g., relatively stale) parameters. Relevant parameters may include one or more parameters that are accurately indicative of a current channel condition of the UE 115. Irrelevant parameters may include one or more parameters that are not accurately indicative of a current channel condition of the UE 115. Further, by not reporting parameters that are not accurately indicative of a current channel condition of the UE 115, the UE 115 may facilitate more suitable handover decisions by avoiding a scenario in which the network entity 105 configures a handover based on inaccurate parameters.

One or more durations of the one or more validity timers 630 may be associated with a capability of the UE 115. Additionally, or alternatively, one or more durations of the one or more validity timers 630 may be associated with a level of mobility of the UE 115 (e.g., based on historical mobility or location metrics of the UE 115). Additionally, or alternatively, one or more durations of the one or more validity timers 630 may be associated with an indication from (e.g., an RRC configuration by) the network entity 105 (e.g., via RRC signaling sent to the UE 115). Additionally, or alternatively, one or more durations of the one or more validity timers 630 may be constant (e.g., fixed, such as in accordance with a network specification).

Additionally, or alternatively, one or more durations of the one or more validity timers 630 may be associated with (e.g., determined by) a function of how many parameters are truncated. For example, the UE 115 may determine a duration of a validity timer in accordance with a quantity of the truncated parameters 620. In some examples, the UE 115 may apply a different multiplier to a baseline validity timer value depending on the quantity of the truncated parameters 620. For example, the UE 115 may apply a first multiplier to the baseline validity timer value in accordance with the truncated parameters 620 including a first quantity of parameters. By way of further example, the UE 115 may apply a second multiplier to the baseline validity timer value in accordance with the truncated parameters 620 including a second quantity of parameters. The duration of such a validity timer may increase as the quantity of the truncated parameters 620 increases. Additionally, or alternatively, a duration of a validity timer may be associated with a priority of one or more of the truncated parameters 620. For example, the duration of such a validity timer may increase as the priority of one or more of the truncated parameters 620 increases.

The UE 115 may receive a second control message 635 indicating an uplink resource allocation 640 via which the UE 115 may transmit a second measurement report 645. In some implementations, the UE 115 may include, within the second measurement report 645, the truncated parameters 620 in accordance with the truncation of the first measurement report 615. In some implementations, the truncated parameters 620 may be associated with relatively higher priorities as compared to one or more other parameters associated with triggering events detected as being satisfied after transmission of the first measurement report 615. The UE 115 may transmit the second measurement report 645 including the truncated parameters 620 after expiry of the prohibit timer 625 and prior to expiry of the one or more validity timers 630. An expiry of the prohibit timer 625 may trigger the transmission of the second measurement report 645 or may allow the transmission of the second measurement report 645.

In some implementations, the UE 115 may provide, indicate, or convey an indication of a truncated or a delayed transmission via a logical channel of a measurement report or a per-triggering event indicator, or via a combination of both. For example, in accordance with at least one of a logical channel of the first measurement report 615 or a per-triggering event indicator within the first measurement report 615, the UE 115 may indicate that the first measurement report 615 is a truncated measurement report (e.g., a measurement report for which at least one triggering event is completely or partially omitted from the measurement report). By way of further example, in accordance with at least one of a logical channel of the second measurement report 645 or a per-triggering event indicator within the second measurement report 645, the UE 115 may indicate that the second measurement report 645 is a delayed measurement report (e.g., a measurement report for which at least one included triggering event was omitted from a previous measurement report).

In some examples, different logical channels may be defined to identify different measurement report types. In some implementations, for example, a first logical channel may implicitly indicate that a measurement report sent via or in association with the first logical channel is a regular measurement report (e.g., a non-truncated measurement report) and a second logical channel may implicitly indicate that a measurement report sent via or in association with the second logical channel is a truncated measurement report (e.g., at least one truncated event present). In some other implementations, a first logical channel may implicitly indicate that a measurement report sent via or in association with the first logical channel is a regular measurement report (e.g., a non-truncated measurement report), a second logical channel may implicitly indicate that a measurement report sent via or in association with the second logical channel is a truncated measurement report (e.g., at least one truncated event present), and a third logical channel may implicitly indicate that a measurement report sent via or in association with the third logical channel is a delayed measurement report (e.g., at least one delayed event present). In some aspects, delayed measurement reports may have a higher priority than other types of measurement reports.

Additionally, or alternatively, each triggering event within a measurement report may be associated with one or more IDs, one or more fields, or a set of one or more bits to indicate whether that triggering event is a truncated triggering event, a non-truncated triggering event, a delayed triggering event, or a non-delayed triggering event. For example, a first value of an ID, a field, or a set of one or more bits may indicate that a corresponding triggering event is a truncated triggering event and a second value of the ID, the field, or the set of one or more bits may indicate that the corresponding triggering event is a non-truncated triggering event. Additionally, or alternatively, a third value of an ID, a field, or a set of one or more bits may indicate that a corresponding triggering event is a delayed triggering event and a fourth value of the ID, the field, or the set of one or more bits may indicate that the corresponding triggering event is a non-delayed triggering event. Such one or more IDs, one or more fields, or one or more bits may include a single ID, a single field, or a single bit or may include multiple IDs, multiple fields, or multiple bits.

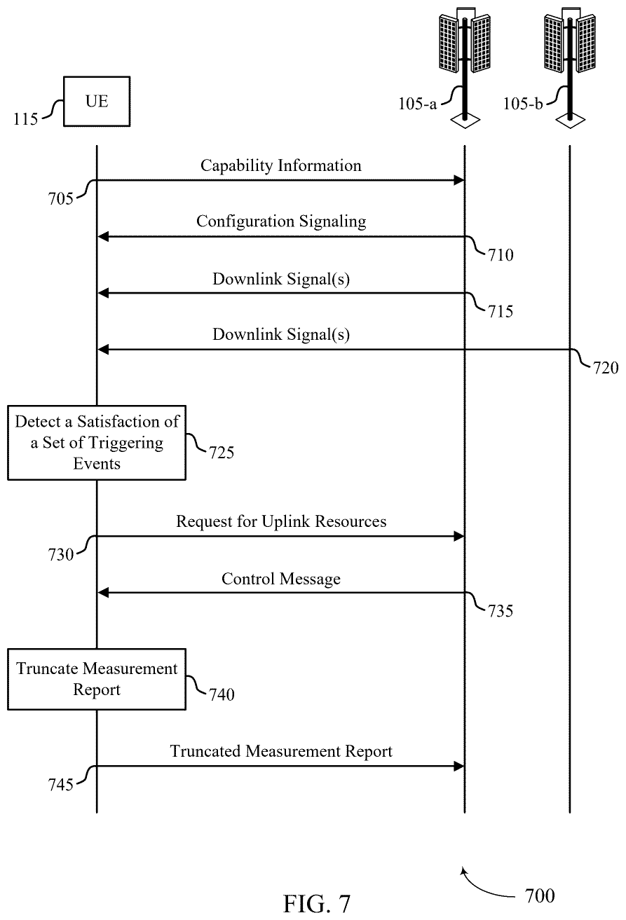

FIG. 7 shows an example of a process flow 700 that supports truncated event-triggered measurement report designs and procedures in LTM in accordance with one or more aspects of the present disclosure. The process flow 700 illustrates communication between a UE 115, a network entity 105-a, and a network entity 105-b, which may be examples of corresponding devices as illustrated and described herein. In some examples, the UE 115 may communicate with the network entity 105-a and the network entity 105-b in accordance with an LTM procedure, such as in accordance with performing and reporting one or more measurements associated with LTM.

In the following description of the process flow 700, the operations between the UE 115, the network entity 105-a, and the network entity 105-b may occur in a different order than the example order shown and, in some examples, may be performed by one or more different devices other than those shown as examples. Some operations also may be omitted from the process flow 700, and other operations may be added to the process flow 700. Further, although some operations or signaling may be shown to occur at different times for discussion purposes, these operations may actually occur at the same time. Additionally, although the UE 115 is illustrated as communicating with the network entity 105-a and the network entity 105-b, the UE 115 may alternatively communicate with a single network entity 105 (e.g., in examples in which the UE 115 measures beams of a single cell or in which a single network entity 105 operates or supports multiple cells).

At 705, the UE 115 may transmit information indicative of a capability of the UE 115 to the network entity 105-a. The UE 115 may indicate, via the information, a capability of the UE 115 associated with LTM measurement reporting (such as a capability associated with one or more triggering events), a capability of the UE 115 associated with performing truncation of an LTM measurement report (such as whether the UE 115 supports truncation of an LTM measurement report or which type(s) of truncation the UE 115 supports), a capability of the UE 115 associated with parameter/triggering event prioritization, or a capability of the UE 115 associated with one or more timers applicable to one or more truncated parameters, among other examples. The UE 115 may transmit the capability information via RRC signaling, one or more MAC-CEs, or one or more uplink control information (UCI) messages.

At 710, the UE 115 may receive configuration signaling from the network entity 105-a. The configuration signaling may indicate information pertaining to LTM measurement reporting (such as information associated with one or more triggering events), information pertaining to truncation of an LTM measurement report (such as whether the UE 115 is configured to perform truncation of an LTM measurement report or which type(s) of truncation the UE 115 is configured to perform), information pertaining to parameter/triggering event prioritization, or information pertaining to one or more timers applicable to one or more truncated parameters, among other examples. Additionally, or alternatively, the UE 115 may receive activation signaling associated with any of such information. The UE 115 may receive the configuration signaling via RRC signaling and may receive the activation signaling via one or more MAC-CEs or one or more downlink control information (DCI) messages, or any combination thereof.

At 715, the UE 115 may receive one or more downlink signals from the network entity 105-a. In some examples, the network entity 105-a may be associated with a serving cell of the UE 115. The UE 115 may perform one or more measurements of the one or more downlink signals, which may be reference signals (e.g., one or more SSBs or one or more CSI-RSs, among other examples).

At 720, the UE 115 may receive one or more downlink signals from the network entity 105-b. In some examples, the network entity 105-b may be associated with a candidate cell for the UE 115. The UE 115 may perform one or more measurements of the one or more downlink signals, which may be reference signals (e.g., one or more SSBs or one or more CSI-RSs, among other examples).

At 725, the UE 115 may detect a satisfaction of a set of triggering events associated with the LTM procedure. The set of triggering events may include a single triggering event or may include multiple triggering events. In some implementations, the satisfaction of the set of triggering events may trigger a transmission of a measurement report (e.g., an event-triggered L1 measurement report associated with LTM) by the UE 115.

At 730, the UE 115 may transmit a request for uplink resources to the network entity 105-a. For example, the UE 115 may transmit a request for uplink resources via which the UE 115 may transmit the measurement report triggered by the satisfaction of the set of triggering events. Alternatively, the UE 115 may refrain from requesting uplink resources via which the UE 115 may transmit the measurement report and may instead use uplink resources otherwise allocated to the UE 115 for transmission of the measurement report.

At 735, the UE 115 may receive a control message from the network entity 105-a, the control message indicating an uplink shared channel (e.g., a PUSCH) resource allocation. In some examples, the uplink shared channel resource allocation may be associated with the LTM procedure. In such examples, the network entity 105-a may provide the uplink shared channel resource allocation to the UE 115 for the UE 115 to transmit an event-triggered L1 measurement report associated with LTM. In some other examples, the uplink shared channel resource allocation may be allocated to the UE 115 for one or more other uplink messages and the UE 115 may use the uplink shared channel resource allocation for transmission of an event-triggered L1 measurement report, instead of or in addition to the one or more other uplink messages.

At 740, as part of preparing or generating the measurement report for transmission, the UE 115 may truncate the measurement report. The UE 115 may truncate the measurement report in accordance with an uplink resource that is available for the measurement being insufficient to carry a non-truncated version of the measurement report. Additionally, or alternatively, the UE 115 may truncate the measurement report in accordance with a condition, such as a condition that instructs or requests the UE 115 to truncate uplink reports to provide sufficient resources, within the uplink shared channel resource allocation, for transmission of at least a lower limit quantity of other uplink reports or at least a lower limit amount of uplink data. The UE 115 may truncate the measurement report in accordance with at least one of an event-wise truncation or a content-wise truncation, such as the event-wise truncation 400 and the content-wise truncation 450 as illustrated by and described with reference to FIGS. 4A and 4B, respectively.

At 745, the UE 115 may transmit the truncated measurement report. The UE 115 may transmit the truncated measurement report via a truncated L1 measurement report MAC-CE. The truncated L1 measurement report MAC-CE may be a single event—single measurement report MAC-CE (e.g., in accordance with the set of satisfied triggering events including a single triggering event) or may be a multiple events—single measurement report MAC-CE (e.g., in accordance with the set of satisfied triggering events including multiple triggering events). In association with transmitting the truncated measurement report, the UE 115 may start one or more timers associated with truncating the measurement report. For example, the UE 115 start at least one of a prohibit timer or one or more validity timers associated with a set of parameters truncated from the measurement report.

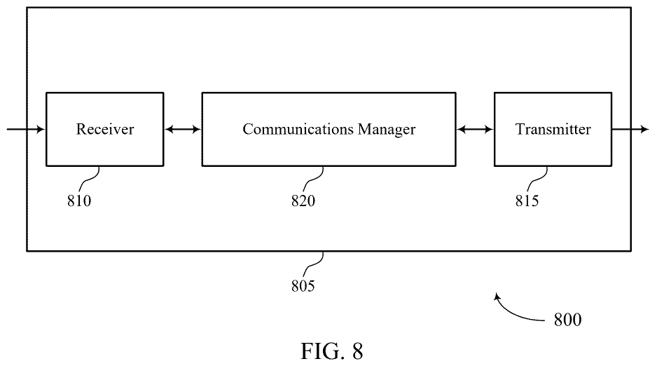

FIG. 8 shows a block diagram 800 of a device 805 that supports truncated event-triggered measurement report designs and procedures in LTM in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to truncated event-triggered measurement report designs and procedures in LTM). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to truncated event-triggered measurement report designs and procedures in LTM). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of truncated event-triggered measurement report designs and procedures in LTM as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a control message that indicates an uplink shared channel resource allocation for measurement reporting associated with an LTM procedure. The communications manager 820 is capable of, configured to, or operable to support a means for transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

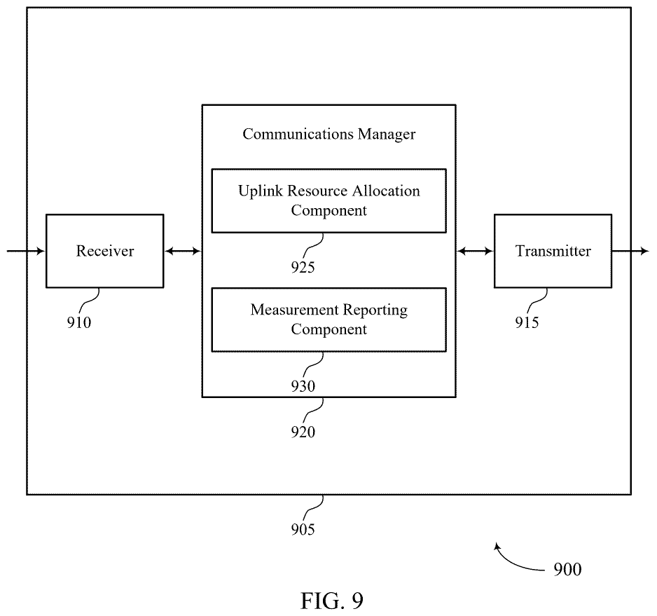

FIG. 9 shows a block diagram 900 of a device 905 that supports truncated event-triggered measurement report designs and procedures in LTM in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to truncated event-triggered measurement report designs and procedures in LTM). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to truncated event-triggered measurement report designs and procedures in LTM). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of truncated event-triggered measurement report designs and procedures in LTM as described herein. For example, the communications manager 920 may include an uplink resource allocation component 925 a measurement reporting component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The uplink resource allocation component 925 is capable of, configured to, or operable to support a means for receiving a control message that indicates an uplink shared channel resource allocation for measurement reporting associated with an LTM procedure. The measurement reporting component 930 is capable of, configured to, or operable to support a means for transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

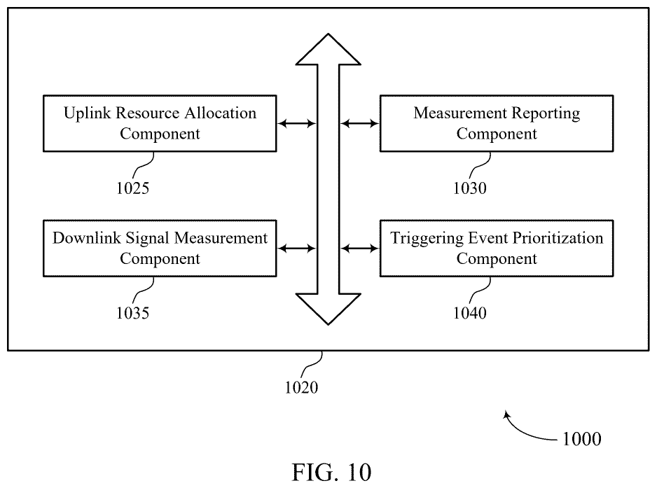

FIG. 10 shows a block diagram 1000 of a communications manager 1020 that supports truncated event-triggered measurement report designs and procedures in LTM in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of truncated event-triggered measurement report designs and procedures in LTM as described herein. For example, the communications manager 1020 may include an uplink resource allocation component 1025, a measurement reporting component 1030, a downlink signal measurement component 1035, a triggering event prioritization component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The uplink resource allocation component 1025 is capable of, configured to, or operable to support a means for receiving a control message that indicates an uplink shared channel resource allocation for measurement reporting associated with an LTM procedure. The measurement reporting component 1030 is capable of, configured to, or operable to support a means for transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

In some examples, the downlink signal measurement component 1035 is capable of, configured to, or operable to support a means for receiving one or more downlink signals associated with at least one of a serving cell or one or more candidate cells, where the satisfaction of the set of triggering events associated with the LTM procedure is based on a measurement of the one or more downlink signals.

In some examples, the measurement report is truncated in accordance with the event-wise truncation. In some examples, the subset of triggering events includes one or more relatively higher priority triggering events as compared to a remainder of the set of triggering events.

In some examples, the triggering event prioritization component 1040 is capable of, configured to, or operable to support a means for receiving information indicative of a respective priority associated with each triggering event configuration of a set of multiple triggering event configurations, where the subset of triggering events is associated with one or more first triggering event configurations and the remainder of the set of triggering events is associated with one or more second triggering event configurations, and where the one or more first triggering event configurations are associated with one or more relatively higher priorities as compared to the one or more second triggering event configurations.

In some examples, each triggering event type of a set of multiple triggering event types is associated with a respective priority. In some examples, the subset of triggering events is associated with one or more first triggering event types and the remainder of the set of triggering events is associated with one or more second triggering event types. In some examples, the one or more first triggering event types are associated with one or more relatively higher priorities as compared to the one or more second triggering event types.

In some examples, the triggering event prioritization component 1040 is capable of, configured to, or operable to support a means for receiving information indicative of a triggering event identifier associated with each triggering event of a set of multiple triggering events, each triggering event identifier associated with a respective priority, where the subset of triggering events is associated with one or more first triggering event identifiers and the remainder of the set of triggering events is associated with one or more second triggering event identifiers, and where the one or more first triggering event identifiers are associated with one or more relatively higher priorities as compared to the one or more second triggering event identifiers.

In some examples, a respective priority associated with each triggering event of the set of triggering events is selected in accordance with an autonomous UE decision.

In some examples, the measurement report is truncated in accordance with the content-wise truncation. In some examples, the subset of parameters includes one or more relatively higher priority parameters as compared to a remainder of the set of parameters associated with the triggering event.

In some examples, each parameter or each parameter group of the set of parameters is associated with a respective priority in accordance with a prioritization rule. In some examples, the subset of parameters includes the one or more relatively higher priority parameters as compared to the remainder of the set of parameters in accordance with the prioritization rule.

In some examples, the measurement report is truncated in accordance with a sequence of the event-wise truncation and the content-wise truncation. In some examples, the sequence defines to initially truncate the measurement report according to the event-wise truncation and to subsequently further truncate the measurement report according to the content-wise truncation in accordance with a size of an event-wise truncated measurement report exceeding the uplink resource within the uplink shared channel resource allocation that is available for the measurement report.

In some examples, the measurement report is truncated in accordance with a sequence of the event-wise truncation and the content-wise truncation. In some examples, the sequence defines to initially truncate the measurement report according to the content-wise truncation and to subsequently further truncate the measurement report according to the event-wise truncation in accordance with a size of a content-wise truncated measurement report exceeding the uplink resource within the uplink shared channel resource allocation that is available for the measurement report.

In some examples, the measurement reporting component 1030 is capable of, configured to, or operable to support a means for receiving information indicative of a condition associated with transmission of uplink reports by the UE, where the condition defines to transmit a truncated uplink report to provide sufficient resources, within the uplink shared channel resource allocation, for transmission of at least a lower limit quantity of other uplink reports or at least a lower limit amount of uplink data, and where the measurement report is truncated in accordance with the condition.

In some examples, the uplink resource allocation component 1025 is capable of, configured to, or operable to support a means for receiving a second control message that indicates a second uplink shared channel resource allocation for the measurement reporting associated with the LTM procedure. In some examples, the measurement reporting component 1030 is capable of, configured to, or operable to support a means for transmitting, via a second uplink resource within the second uplink shared channel resource allocation, a second measurement report that includes, in accordance with the measurement report being truncated, at least one of one or more other parameters associated with at least one triggering event of a remainder of one or more triggering events of the set of triggering events outside of the subset of triggering events or a remainder of one or more parameters of the set of parameters associated with the triggering event outside of the subset of parameters.

In some examples, the second measurement report is transmitted prior to an expiry of one or more validity timers, defined relative to a transmission time of the measurement report, that are associated with at least one of the one or more other parameters associated with the at least one triggering event of the remainder of one or more triggering events of the set of triggering events outside of the subset of triggering events or the remainder of one or more parameters of the set of parameters associated with the triggering event outside of the subset of parameters.

In some examples, the second measurement report is transmitted after an expiry of a prohibit timer, defined relative to a transmission time of the measurement report, that is associated with a quantity of parameters truncated from the measurement report.

In some examples, the measurement report is associated with a logical channel, of a set of multiple logical channels, in accordance with the measurement report being truncated.

In some examples, the set of multiple logical channels includes two or more of a set including a first logical channel that indicates an absence of any truncation within a transmitted measurement report, a second logical channel that indicates a presence of at least one truncated triggering event within the transmitted measurement report, and a third logical channel that indicates a presence of at least one delayed triggering event within the transmitted measurement report.

In some examples, the measurement report includes a respective indication, for each triggering event for which at least one parameter is included within the measurement report, of whether that triggering event is a truncated triggering event, a non-truncated triggering event, a delayed triggering event, or a non-delayed triggering event.

In some examples, the set of triggering events consists of a single triggering event, the measurement report truncated in accordance with the content-wise truncation in association with the set of triggering events consisting of the single triggering event. In some examples, the set of triggering events includes a set of multiple triggering events, the measurement report truncated in accordance with one or both of the event-wise truncation or the content-wise truncation in association with the set of triggering events including the set of multiple triggering events.

In some examples, the uplink resource within the uplink shared channel resource allocation that is available for the measurement report is insufficient to carry a non-truncated version of the measurement report. In some examples, the measurement report is truncated based on the uplink resource being insufficient to carry the non-truncated version of the measurement report.

In some examples, in accordance with the event-wise truncation, one or more other parameters associated with a remainder of one or more triggering events of the set of triggering events outside of the subset of triggering events are excluded from the measurement report. In some examples, in accordance with the content-wise truncation, a remainder of one or more parameters of the set of parameters associated with the triggering event outside of the subset of parameters are excluded from the measurement report.

In some examples, the measurement report is transmitted via a truncated L1 measurement report MAC-CE.

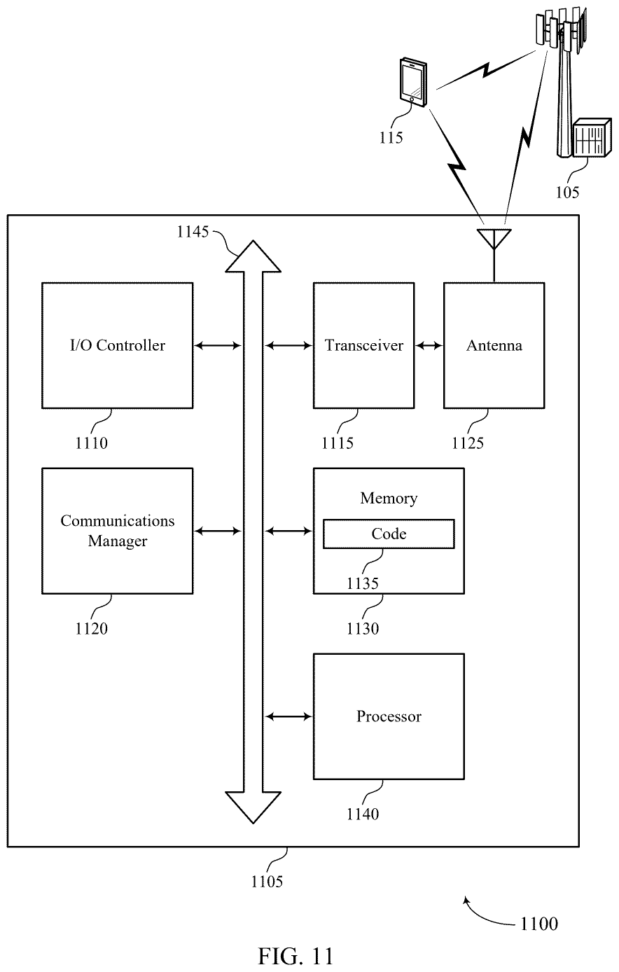

FIG. 11 shows a diagram of a system 1100 including a device 1105 that supports truncated event-triggered measurement report designs and procedures in LTM in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting truncated event-triggered measurement report designs and procedures in LTM). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving a control message that indicates an uplink shared channel resource allocation for measurement reporting associated with an LTM procedure. The communications manager 1120 is capable of, configured to, or operable to support a means for transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of truncated event-triggered measurement report designs and procedures in LTM as described herein, or the at least one processor 1140 and the at least one memory 1130 may be otherwise configured to, individually or collectively, perform or support such operations.

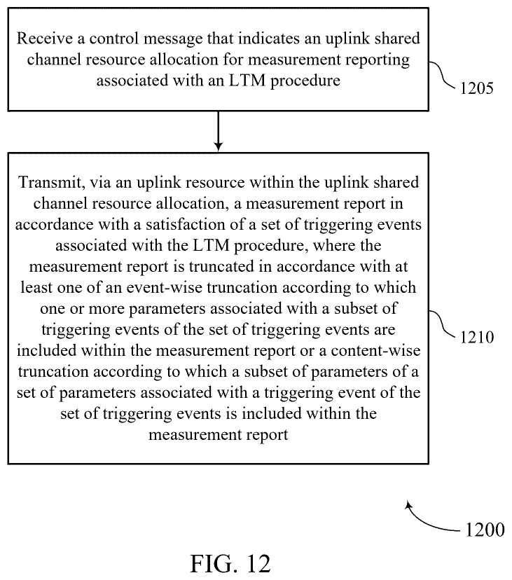

FIG. 12 shows a flowchart illustrating a method 1200 that supports truncated event-triggered measurement report designs and procedures in LTM in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a control message that indicates an uplink shared channel resource allocation for measurement reporting associated with an LTM procedure. The operations of 1205 may be performed in accordance with examples as disclosed herein. In some examples, aspects of the operations of 1205 may be performed by an uplink resource allocation component 1025 as described with reference to FIG. 10.

At 1210, the method may include transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report. The operations of 1210 may be performed in accordance with examples as disclosed herein. In some examples, aspects of the operations of 1210 may be performed by a measurement reporting component 1030 as described with reference to FIG. 10.

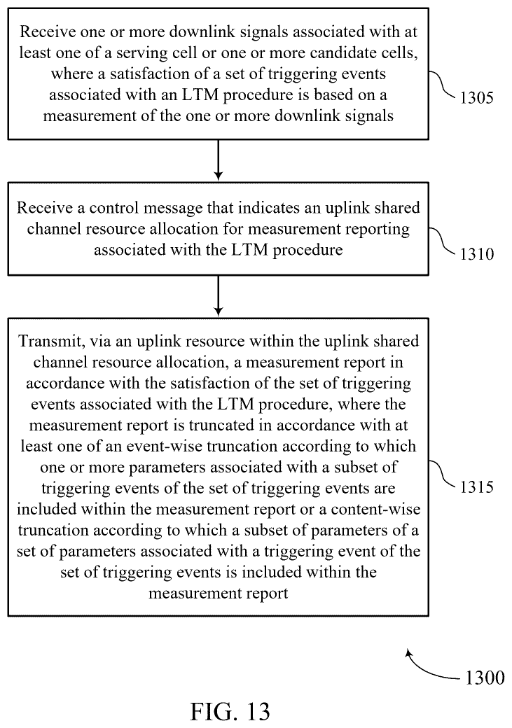

FIG. 13 shows a flowchart illustrating a method 1300 that supports truncated event-triggered measurement report designs and procedures in LTM in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving one or more downlink signals associated with at least one of a serving cell or one or more candidate cells, where a satisfaction of a set of triggering events associated with an LTM procedure is based on a measurement of the one or more downlink signals. The operations of 1305 may be performed in accordance with examples as disclosed herein. In some examples, aspects of the operations of 1305 may be performed by a downlink signal measurement component 1035 as described with reference to FIG. 10.

At 1310, the method may include receiving a control message that indicates an uplink shared channel resource allocation for measurement reporting associated with the LTM procedure. The operations of 1310 may be performed in accordance with examples as disclosed herein. In some examples, aspects of the operations of 1310 may be performed by an uplink resource allocation component 1025 as described with reference to FIG. 10.

At 1315, the method may include transmitting, via an uplink resource within the uplink shared channel resource allocation, a measurement report in accordance with the satisfaction of the set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report. The operations of 1315 may be performed in accordance with examples as disclosed herein. In some examples, aspects of the operations of 1315 may be performed by a measurement reporting component 1030 as described with reference to FIG. 10.

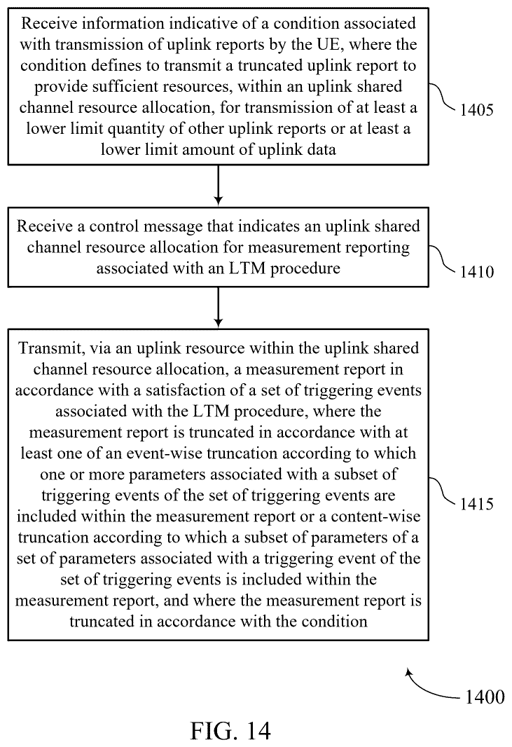

FIG. 14 shows a flowchart illustrating a method 1400 that supports truncated event-triggered measurement report designs and procedures in LTM in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving information indicative of a condition associated with transmission of uplink reports by the UE, where the condition defines to transmit a truncated uplink report to provide sufficient resources, within an uplink shared channel resource allocation, for transmission of at least a lower limit quantity of other uplink reports or at least a lower limit amount of uplink data. The operations of 1405 may be performed in accordance with examples as disclosed herein. In some examples, aspects of the operations of 1405 may be performed by a measurement reporting component 1030 as described with reference to FIG. 10.

At 1410, the method may include receiving a control message that indicates an uplink shared channel resource allocation for measurement reporting associated with an LTM procedure. The operations of 1410 may be performed in accordance with examples as disclosed herein. In some examples, aspects of the operations of 1410 may be performed by an uplink resource allocation component 1025 as described with reference to FIG. 10.

At 1415, the method may include transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report, and where the measurement report is truncated in accordance with the condition. The operations of 1415 may be performed in accordance with examples as disclosed herein. In some examples, aspects of the operations of 1415 may be performed by a measurement reporting component 1030 as described with reference to FIG. 10.

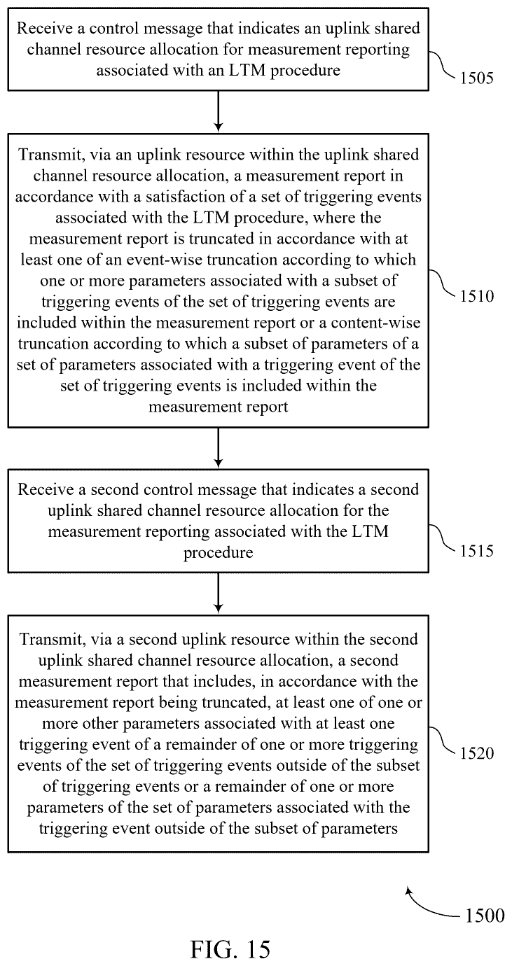

FIG. 15 shows a flowchart illustrating a method 1500 that supports truncated event-triggered measurement report designs and procedures in LTM in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving a control message that indicates an uplink shared channel resource allocation for measurement reporting associated with an LTM procedure. The operations of 1505 may be performed in accordance with examples as disclosed herein. In some examples, aspects of the operations of 1505 may be performed by an uplink resource allocation component 1025 as described with reference to FIG. 10.

At 1510, the method may include transmitting, via an uplink resource within the uplink shared channel resource allocation, a measurement report in accordance with a satisfaction of a set of triggering events associated with the LTM procedure, where the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report. The operations of 1510 may be performed in accordance with examples as disclosed herein. In some examples, aspects of the operations of 1510 may be performed by a measurement reporting component 1030 as described with reference to FIG. 10.

At 1515, the method may include receiving a second control message that indicates a second uplink shared channel resource allocation for the measurement reporting associated with the LTM procedure. The operations of 1515 may be performed in accordance with examples as disclosed herein. In some examples, aspects of the operations of 1515 may be performed by an uplink resource allocation component 1025 as described with reference to FIG. 10.

At 1520, the method may include transmitting, via a second uplink resource within the second uplink shared channel resource allocation, a second measurement report that includes, in accordance with the measurement report being truncated, at least one of one or more other parameters associated with at least one triggering event of a remainder of one or more triggering events of the set of triggering events outside of the subset of triggering events or a remainder of one or more parameters of the set of parameters associated with the triggering event outside of the subset of parameters. The operations of 1520 may be performed in accordance with examples as disclosed herein. In some examples, aspects of the operations of 1520 may be performed by a measurement reporting component 1030 as described with reference to FIG. 10.

The following provides an overview of aspects of the present disclosure:

Aspect 1: A method for wireless communications at a UE, comprising: receiving a control message that indicates an uplink shared channel resource allocation for measurement reporting associated with an LTM procedure; and transmitting, via an uplink resource within the uplink shared channel resource allocation, a measurement report in accordance with a satisfaction of a set of triggering events associated with the LTM procedure, wherein the measurement report is truncated in accordance with at least one of an event-wise truncation according to which one or more parameters associated with a subset of triggering events of the set of triggering events are included within the measurement report or a content-wise truncation according to which a subset of parameters of a set of parameters associated with a triggering event of the set of triggering events is included within the measurement report.

Aspect 2: The method of aspect 1, further comprising: receiving one or more downlink signals associated with at least one of a serving cell or one or more candidate cells, wherein the satisfaction of the set of triggering events associated with the LTM procedure is based at least in part on a measurement of the one or more downlink signals.

Aspect 3: The method of any of aspects 1-2, wherein the measurement report is truncated in accordance with the event-wise truncation, and the subset of triggering events comprises one or more relatively higher priority triggering events as compared to a remainder of the set of triggering events.

Aspect 4: The method of aspect 3, further comprising: receiving information indicative of a respective priority associated with each triggering event configuration of a plurality of triggering event configurations, wherein the subset of triggering events is associated with one or more first triggering event configurations and the remainder of the set of triggering events is associated with one or more second triggering event configurations, and wherein the one or more first triggering event configurations are associated with one or more relatively higher priorities as compared to the one or more second triggering event configurations.

Aspect 5: The method of any of aspects 3-4, wherein each triggering event type of a plurality of triggering event types is associated with a respective priority; the subset of triggering events is associated with one or more first triggering event types and the remainder of the set of triggering events is associated with one or more second triggering event types; and the one or more first triggering event types are associated with one or more relatively higher priorities as compared to the one or more second triggering event types.

Aspect 6: The method of any of aspects 3-5, further comprising: receiving information indicative of a triggering event identifier associated with each triggering event of a plurality of triggering events, each triggering event identifier associated with a respective priority, wherein the subset of triggering events is associated with one or more first triggering event identifiers and the remainder of the set of triggering events is associated with one or more second triggering event identifiers, and wherein the one or more first triggering event identifiers are associated with one or more relatively higher priorities as compared to the one or more second triggering event identifiers.

Aspect 7: The method of any of aspects 3-6, wherein a respective priority associated with each triggering event of the set of triggering events is selected in accordance with an autonomous UE decision.

Aspect 8: The method of any of aspects 1-7, wherein the measurement report is truncated in accordance with the content-wise truncation, and the subset of parameters comprises one or more relatively higher priority parameters as compared to a remainder of the set of parameters associated with the triggering event.

Aspect 9: The method of aspect 8, wherein each parameter or each parameter group of the set of parameters is associated with a respective priority in accordance with a prioritization rule; and the subset of parameters comprises the one or more relatively higher priority parameters as compared to the remainder of the set of parameters in accordance with the prioritization rule.

Aspect 10: The method of any of aspects 1-9, wherein the measurement report is truncated in accordance with a sequence of the event-wise truncation and the content-wise truncation; and the sequence defines to initially truncate the measurement report according to the event-wise truncation and to subsequently further truncate the measurement report according to the content-wise truncation in accordance with a size of an event-wise truncated measurement report exceeding the uplink resource within the uplink shared channel resource allocation that is available for the measurement report.

Aspect 11: The method of any of aspects 1-9, wherein the measurement report is truncated in accordance with a sequence of the event-wise truncation and the content-wise truncation; and the sequence defines to initially truncate the measurement report according to the content-wise truncation and to subsequently further truncate the measurement report according to the event-wise truncation in accordance with a size of a content-wise truncated measurement report exceeding the uplink resource within the uplink shared channel resource allocation that is available for the measurement report.

Aspect 12: The method of any of aspects 1-11, further comprising: receiving information indicative of a condition associated with transmission of uplink reports by the UE, wherein the condition defines to transmit a truncated uplink report to provide sufficient resources, within the uplink shared channel resource allocation, for transmission of at least a lower limit quantity of other uplink reports or at least a lower limit amount of uplink data, and wherein the measurement report is truncated in accordance with the condition.

Aspect 13: The method of any of aspects 1-12, further comprising: receiving a second control message that indicates a second uplink shared channel resource allocation for the measurement reporting associated with the LTM procedure; and transmitting, via a second uplink resource within the second uplink shared channel resource allocation, a second measurement report that includes, in accordance with the measurement report being truncated, at least one of one or more other parameters associated with at least one triggering event of a remainder of one or more triggering events of the set of triggering events outside of the subset of triggering events or a remainder of one or more parameters of the set of parameters associated with the triggering event outside of the subset of parameters.

Aspect 14: The method of aspect 13, wherein the second measurement report is transmitted prior to an expiry of one or more validity timers, defined relative to a transmission time of the measurement report, that are associated with at least one of the one or more other parameters associated with the at least one triggering event of the remainder of one or more triggering events of the set of triggering events outside of the subset of triggering events or the remainder of one or more parameters of the set of parameters associated with the triggering event outside of the subset of parameters.

Aspect 15: The method of any of aspects 13-14, wherein the second measurement report is transmitted after an expiry of a prohibit timer, defined relative to a transmission time of the measurement report, that is associated with a quantity of parameters truncated from the measurement report.

Aspect 16: The method of any of aspects 1-15, wherein the measurement report is associated with a logical channel, of a plurality of logical channels, in accordance with the measurement report being truncated.

Aspect 17: The method of aspect 16, wherein the plurality of logical channels comprises two or more of a set including a first logical channel that indicates an absence of any truncation within a transmitted measurement report, a second logical channel that indicates a presence of at least one truncated triggering event within the transmitted measurement report, and a third logical channel that indicates a presence of at least one delayed triggering event within the transmitted measurement report.

Aspect 18: The method of any of aspects 1-17, wherein the measurement report comprises a respective indication, for each triggering event for which at least one parameter is included within the measurement report, of whether that triggering event is a truncated triggering event, a non-truncated triggering event, a delayed triggering event, or a non-delayed triggering event.

Aspect 19: The method of any of aspects 1-18, wherein the set of triggering events consists of a single triggering event, the measurement report truncated in accordance with the content-wise truncation in association with the set of triggering events consisting of the single triggering event; or the set of triggering events comprises a plurality of triggering events, the measurement report truncated in accordance with one or both of the event-wise truncation or the content-wise truncation in association with the set of triggering events comprising the plurality of triggering events.

Aspect 20: The method of any of aspects 1-19, wherein the uplink resource within the uplink shared channel resource allocation that is available for the measurement report is insufficient to carry a non-truncated version of the measurement report, and the measurement report is truncated based at least in part on the uplink resource being insufficient to carry the non-truncated version of the measurement report.

Aspect 21: The method of any of aspects 1-20, wherein in accordance with the event-wise truncation, one or more other parameters associated with a remainder of one or more triggering events of the set of triggering events outside of the subset of triggering events are excluded from the measurement report; and in accordance with the content-wise truncation, a remainder of one or more parameters of the set of parameters associated with the triggering event outside of the subset of parameters are excluded from the measurement report.

Aspect 22: The method of any of aspects 1-21, wherein the measurement report is transmitted via a truncated L1 measurement report MAC-CE.

Aspect 23: A UE for wireless communications, comprising one or more memories storing processor-executable code, and one or more processors coupled with the one or more memories and individually or collectively operable to execute the code to cause the UE to perform a method of any of aspects 1-22.

Aspect 24: A UE for wireless communications, comprising at least one means for performing a method of any of aspects 1-22.

Aspect 25: A non-transitory computer-readable medium storing code for wireless communications, the code comprising instructions executable by one or more processors to perform a method of any of aspects 1-22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that indicates an uplink shared channel resource allocation for measurement reporting associated with a lower-layer triggered mobility procedure; and
transmit, via an uplink resource within the uplink shared channel resource allocation, a measurement report in accordance with a satisfaction of a set of triggering events associated with the lower-layer triggered mobility procedure, wherein the measurement report is truncated in accordance with at least one of:
an event-wise truncation according to which one or more parameters associated with a subset of triggering events of the set of triggering events are included within the measurement report; or
a content-wise truncation according to which a subset of parameters of a set of parameters associated with a triggering event of the set of triggering events is included within the measurement report.

2. The UE of claim 1, wherein the measurement report is truncated in accordance with the event-wise truncation, and wherein the subset of triggering events comprises one or more relatively higher priority triggering events as compared to a remainder of the set of triggering events.

3. The UE of claim 2, wherein the one or more processors are individually or collectively further operable to execute the code to cause the UE to:
receive information indicative of a respective priority associated with each triggering event configuration of a plurality of triggering event configurations, wherein:
the subset of triggering events is associated with one or more first triggering event configurations and the remainder of the set of triggering events is associated with one or more second triggering event configurations, and
the one or more first triggering event configurations are associated with one or more relatively higher priorities as compared to the one or more second triggering event configurations.

4. The UE of claim 2, wherein:
each triggering event type of a plurality of triggering event types is associated with a respective priority;
the subset of triggering events is associated with one or more first triggering event types and the remainder of the set of triggering events is associated with one or more second triggering event types; and
the one or more first triggering event types are associated with one or more relatively higher priorities as compared to the one or more second triggering event types.

5. The UE of claim 2, wherein the one or more processors are individually or collectively further operable to execute the code to cause the UE to:
receive information indicative of a triggering event identifier associated with each triggering event of a plurality of triggering events, each triggering event identifier associated with a respective priority, wherein:
the subset of triggering events is associated with one or more first triggering event identifiers and the remainder of the set of triggering events is associated with one or more second triggering event identifiers, and
the one or more first triggering event identifiers are associated with one or more relatively higher priorities as compared to the one or more second triggering event identifiers.

6. The UE of claim 2, wherein a respective priority associated with each triggering event of the set of triggering events is selected in accordance with an autonomous UE decision.

7. The UE of claim 1, wherein the measurement report is truncated in accordance with the content-wise truncation, and wherein the subset of parameters comprises one or more relatively higher priority parameters as compared to a remainder of the set of parameters associated with the triggering event.

8. The UE of claim 1, wherein:
the measurement report is truncated in accordance with a sequence of the event-wise truncation and the content-wise truncation; and
the sequence defines to initially truncate the measurement report according to the event-wise truncation and to subsequently further truncate the measurement report according to the content-wise truncation in accordance with a size of an event-wise truncated measurement report exceeding the uplink resource within the uplink shared channel resource allocation that is available for the measurement report.

9. The UE of claim 1, wherein:
the measurement report is truncated in accordance with a sequence of the event-wise truncation and the content-wise truncation; and
the sequence defines to initially truncate the measurement report according to the content-wise truncation and to subsequently further truncate the measurement report according to the event-wise truncation in accordance with a size of a content-wise truncated measurement report exceeding the uplink resource within the uplink shared channel resource allocation that is available for the measurement report.

10. The UE of claim 1, wherein the one or more processors are individually or collectively further operable to execute the code to cause the UE to:
receive information indicative of a condition associated with transmission of uplink reports by the UE, wherein:
the condition defines to transmit a truncated uplink report to provide sufficient resources, within the uplink shared channel resource allocation, for transmission of at least a lower limit quantity of other uplink reports or at least a lower limit amount of uplink data, and
the measurement report is truncated in accordance with the condition.

11. The UE of claim 1, wherein the uplink resource within the uplink shared channel resource allocation that is available for the measurement report is insufficient to carry a non-truncated version of the measurement report, and wherein the measurement report is truncated based at least in part on the uplink resource being insufficient to carry the non-truncated version of the measurement report.

12. The UE of claim 1, wherein:
in accordance with the event-wise truncation, one or more other parameters associated with a remainder of one or more triggering events of the set of triggering events outside of the subset of triggering events are excluded from the measurement report; and
in accordance with the content-wise truncation, a remainder of one or more parameters of the set of parameters associated with the triggering event outside of the subset of parameters are excluded from the measurement report.

13. A method for wireless communications at a user equipment (UE), comprising:
receiving a control message that indicates an uplink shared channel resource allocation for measurement reporting associated with a lower-layer triggered mobility procedure; and
transmitting, via an uplink resource within the uplink shared channel resource allocation, a measurement report in accordance with a satisfaction of a set of triggering events associated with the lower-layer triggered mobility procedure, wherein the measurement report is truncated in accordance with at least one of:
an event-wise truncation according to which one or more parameters associated with a subset of triggering events of the set of triggering events are included within the measurement report; or
a content-wise truncation according to which a subset of parameters of a set of parameters associated with a triggering event of the set of triggering events is included within the measurement report.

14. The method of claim 13, further comprising:
receiving a second control message that indicates a second uplink shared channel resource allocation for the measurement reporting associated with the lower-layer triggered mobility procedure; and
transmitting, via a second uplink resource within the second uplink shared channel resource allocation, a second measurement report that includes, in accordance with the measurement report being truncated, at least one of:
one or more other parameters associated with at least one triggering event of a remainder of one or more triggering events of the set of triggering events outside of the subset of triggering events; or
a remainder of one or more parameters of the set of parameters associated with the triggering event outside of the subset of parameters.

15. The method of claim 14, wherein the second measurement report is transmitted prior to an expiry of one or more validity timers, defined relative to a transmission time of the measurement report, that are associated with at least one of:
the one or more other parameters associated with the at least one triggering event of the remainder of one or more triggering events of the set of triggering events outside of the subset of triggering events; or
the remainder of one or more parameters of the set of parameters associated with the triggering event outside of the subset of parameters.

16. The method of claim 14, wherein the second measurement report is transmitted after an expiry of a prohibit timer, defined relative to a transmission time of the measurement report, that is associated with a quantity of parameters truncated from the measurement report.

17. The method of claim 13, wherein the measurement report is associated with a logical channel, of a plurality of logical channels, in accordance with the measurement report being truncated, and wherein the plurality of logical channels comprises two or more of a set including:
a first logical channel that indicates an absence of any truncation within a transmitted measurement report;
a second logical channel that indicates a presence of at least one truncated triggering event within the transmitted measurement report; and
a third logical channel that indicates a presence of at least one delayed triggering event within the transmitted measurement report.

18. The method of claim 13, wherein the measurement report comprises a respective indication, for each triggering event for which at least one parameter is included within the measurement report, of whether that triggering event is a truncated triggering event, a non-truncated triggering event, a delayed triggering event, or a non-delayed triggering event.

19. A user equipment (UE) for wireless communications, comprising:
means for receiving a control message that indicates an uplink shared channel resource allocation for measurement reporting associated with a lower-layer triggered mobility procedure; and
means for transmitting, via an uplink resource within the uplink shared channel resource allocation, a measurement report in accordance with a satisfaction of a set of triggering events associated with the lower-layer triggered mobility procedure, wherein the measurement report is truncated in accordance with at least one of:
an event-wise truncation according to which one or more parameters associated with a subset of triggering events of the set of triggering events are included within the measurement report; or
a content-wise truncation according to which a subset of parameters of a set of parameters associated with a triggering event of the set of triggering events is included within the measurement report.

20. The UE of claim 19, further comprising:
means for receiving one or more downlink signals associated with at least one of a serving cell or one or more candidate cells,
wherein the satisfaction of the set of triggering events associated with the lower-layer triggered mobility procedure is based at least in part on a measurement of the one or more downlink signals.
